(19) United States
(12) Patent Application Publication
(10) Pub. No.: US 2025/0362802 A1
(43) Pub. Date: Nov. 27, 2025

(54) DYNAMICALLY ADJUSTING USER INTERFACES FOR ENHANCED INTERACTION IN DIGITAL APPLICATIONS

(71) Applicant: Nvidia Corporation, Santa Clara, CA (US)

(72) Inventor: Andrew Fear, Cedar Park, TX (US)

(21) Appl. No.: 18/669,877

(22) Filed: May 21, 2024

(51) Int. Cl. G06F 3/04886; A63F 13/2145; A63F 13/22; G06F 3/04842

(52) U.S. Cl. CPC G06F 3/04886; G06F 3/04842; A63F 13/2145; A63F 13/22

(57) ABSTRACT

Approaches of the disclosure are directed towards dynamic and automatic user interface adjustment that accounts for drift in the finger or position of a user over time while providing touch input without direct tactile feedback. Due to a lack of tactile response, a tap position of a finger may drift over time. To compensate for this drift, the touch positions of a user can be monitored over time and compared to regions of the touch interface that are associated with specific inputs. For at least certain types of inputs, it can be determined when there is a pattern or direction of drift that may lead to problems with missed input. Based on the detected drift, the location or screen region associated with that input can be shifted by an appropriate magnitude, as may be based in part upon the magnitude of drift or screen real estate, among other such factors.

### BACKGROUND

In digital environments ranging from mobile gaming to virtual reality applications, users (e.g., players) often interact with interfaces via touch, either on screens or through gesture-sensitive spaces. These systems typically lack physical feedback, which can lead to potential issues such as finger drift. Such an issue occurs when users' fingers inadvertently move away from the designated interaction zones, resulting in failed input commands. For instance, in mobile gaming, as users engage in prolonged gaming sessions, their fingers tend to move away from designated touch control areas without realizing it. This misplacement results in taps that fail to register as intended game interactions, causing frustration and a disjointed gaming experience. Similarly, in virtual reality, gestures may miss their target if the positioning of the user's hand drifts from the intended control zones.

### BRIEF DESCRIPTION OF THE DRAWINGS

Various embodiments in accordance with the present disclosure will be described with reference to the drawings, in which:

FIG. 1 illustrates an example gaming user interface (UI) with various control buttons, according to at least one embodiment;

FIG. 2 illustrates an example gaming UI with an illustration of a user's finger on the touch screen, according to at least one embodiment;

FIG. 3 illustrates an example gaming UI with an illustration of the user's finger drifting from its original position, according to at least one embodiment;

FIG. 4 illustrates an example gaming UI with an illustration of a dynamic UI adjustment based on a detection of the user's finger drift, according to at least one embodiment;

FIG. 5 illustrates an interactive virtual reality (VR) interface, as perceived through a head-mounted display, where dynamic adjustment to UI elements may be performed, according to at least one embodiment;

FIG. 6 illustrates an example process for performing dynamic UI adjustments, according to at least one embodiment;

FIG. 7 illustrates an example process for performing dynamic UI adjustments, according to at least one embodiment;

FIG. 8 illustrates an example system including a dynamic UI adjustment module, according to at least one embodiment;

FIG. 9A illustrates inference and/or training logic, according to at least one embodiment;

FIG. 9B illustrates inference and/or training logic, according to at least one embodiment;

FIG. 10 illustrates an example data center system, according to at least one embodiment;

FIG. 11 illustrates a computer system, according to at least one embodiment;

FIG. 12 illustrates a computer system, according to at least one embodiment;

FIG. 13 illustrates at least portions of a graphics processor, according to one or more embodiments;

FIG. 14 illustrates at least portions of a graphics processor, according to one or more embodiments;

FIG. 15 is an example data flow diagram for an advanced computing pipeline, in accordance with at least one embodiment;

FIG. 16 is a system diagram for an example system for training, adapting, instantiating and deploying machine learning models in an advanced computing pipeline, in accordance with at least one embodiment; and

FIGS. 17A and 17B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

Approaches in accordance with various embodiments of the disclosure are directed towards dynamic and automatic user interface adjustment that accounts for drift in the finger or position of a user over time while providing user input (e.g., touch input, gesture input, etc.) without direct tactile, haptic, or physical feedback. Due in part to a lack of tactile response, such as when a user is tapping on a flat touch screen when playing a game, a tap position of a finger may drift over time, which may result in a user inadvertently failing to properly touch a specific screen region associated with an intended input or action. In response to not providing the desired input, the user typically needs to visually confirm (e.g., by looking back down at the user interface) to determine the proper input region and then make any necessary adjustment(s). This requires taking the user's eyes off the game, which can potentially lead to an undesired event or occurrence in the game, or at least can take away from the immersion of the gaming experience. To compensate for this drift, the input positions (e.g., tap or touch positions, etc.) of a user can be monitored over time and compared to regions of the touch interface that are associated with specific inputs. For at least certain types of inputs, it can be determined when there is a pattern or direction of drift that may lead to problems with missed input. Based on the detected drift, the location or screen region associated with that input can be shifted by an appropriate magnitude, as may be based in part upon the magnitude of drift or screen real estate, among other such factors. Related inputs, or nearby inputs, may be shifted as well based on the detected drift. In this way, a user can keep playing without taking the user's eyes off the game, and the input regions can be dynamically and continually shifted (up to a maximum magnitude, which may vary by user, game, or developer) to account for any determined drift over time. Users and developers can determine whether to activate this functionality, as well as an extent to which to implement. Such dynamic adjustment can be used with applications such as VR (virtual reality) as well and is not limited to gaming input.

Approaches in accordance with at least one embodiment may provide several technical advantages and improvements. For example, approaches focused on dynamically adjusting user interfaces (e.g., touch interfaces) and interface regions enhance the user experience in environments where physical feedback is absent, such as in virtual touch controls used in gaming and virtual reality applications. By intelligently shifting the touch zones to align with the user's movements, these methods address the issue of input accuracy that arises due to the lack of tactile feedback. Such dynamic adjustments not only minimize the common frustration associated with missed taps and unresponsive gestures but also ensure a more fluid and engaging interaction with digital content. The adaptability of such dynamic user interface adjustments effectively simulates a responsive environment, which makes the touch interaction feel more natural and intuitive despite the absence of physical buttons or controls.

Moreover, approaches in accordance with at least one embodiment may offer improvements in the precision and effectiveness of user interfaces across various devices by intelligently determining when and how to make adjustments by employing heuristic algorithms or machine learning algorithms. These algorithms may analyze input data to identify historical patterns of drift. When a certain percentage of drift is detected, adjustments are made to the user interface to ensure that the modifications are specifically targeted and relevant to the drift. Such dynamic adjustments are made in real-time to address the challenges posed by the absence of physical feedback.

Additionally, approaches in accordance with at least one embodiment may provide customization and adaptability of user interfaces. By enabling users to adjust the sensitivity of the user interface adjustments via a slider or selection mechanism, these approaches allow for a personalized interaction experience. Such a feature may provide users the control to set the responsiveness of the dynamic adjustment based on their individual preferences and specific application needs. Additionally, the capability to turn off the dynamic adjustment function offers further flexibility, which ensures that users who prefer a more static user interface can maintain their desired level of interaction consistency. These customization options make it adaptable to a spectrum of user behaviors and preferences, which makes digital interactions more inclusive and user-friendly.

Variations of this and other such functionality can be used as well within the scope of the various embodiments as would be apparent to one of ordinary skill in the art in light of the teachings and suggestions contained herein.

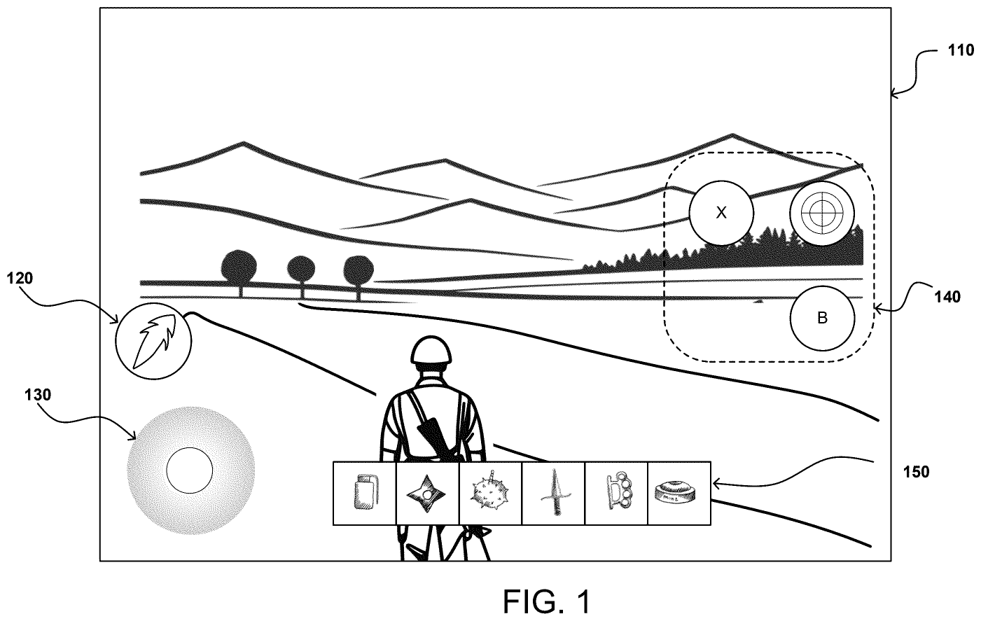

FIG. 1 illustrates an example user interface (UI) layout in an example mobile gaming application. The interface 110 may include a diverse array of touch-responsive areas and functionalities available to the user during gameplay. As illustrated in FIG. 1, the interface 110 may present an in-game environment where the user controls a character or figure, as depicted as the soldier at the bottom center of the display. In this virtual landscape, the user may traverse diverse terrains, encounter enemies, and engage in battles at any moment, which necessitates a range of responsive controls for optimal gameplay. The interface 110 may be composed of various virtual buttons and controls that facilitate interactive gaming experiences on touchscreen devices. The fire button 120 allows the user to execute combat moves such as shooting or striking, which is critical for encounters with adversaries within the game. The directional control panel 130, which is illustrated by a virtual joystick, enables the user to navigate the character through the game's environment such as a rugged battlefield, urban landscape, or mystical terrain. As illustrated in FIG. 1, to the right of the interface 110, a cluster of action buttons 140 may provide additional functionalities necessary for in-game actions like jumping, crouching, or accessing special abilities. These controls must be intuitively accessible, as quick reflexes are often required during sudden combat scenarios. The lower segment of the interface 110 presents a series of square buttons 150, designated for quick weapon or item selection. Each button is visually distinct, represented by an icon that correlates to a different piece of equipment or ability, which ensures that the user can easily adapt their tactics as the dynamic game environment evolves and the intensity of battle fluctuates.

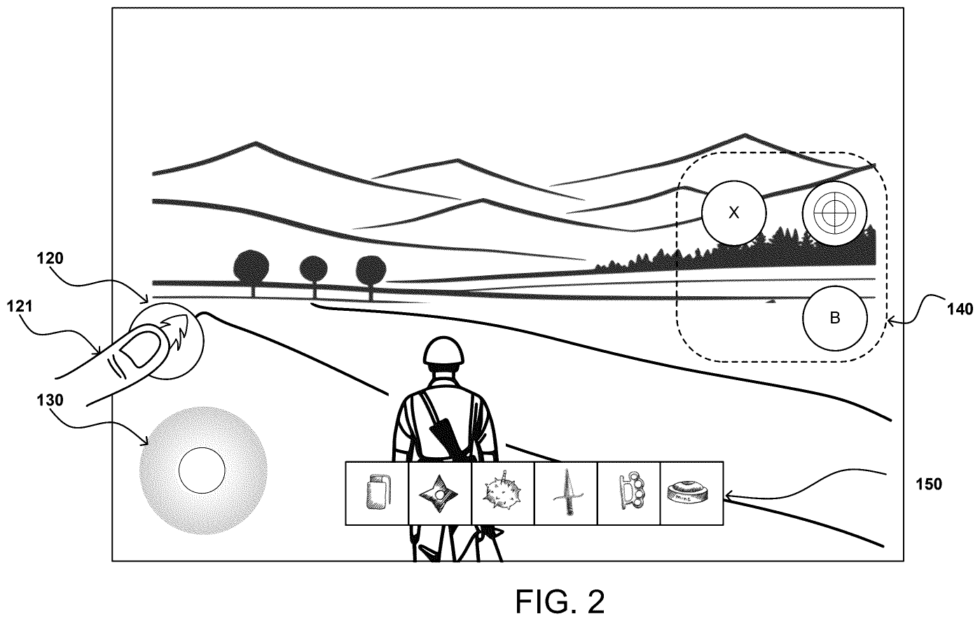

In FIG. 2, a user may engage in an ongoing battle within the game illustrated in FIG. 1. The user's finger 121 may interact with the fire button 120. The user's finger 121 may be in the act of repeatedly pressing the fire button 120 as the user is engaged in a high-intensity combat situation where the user must maintain focused attention on the screen to monitor enemy movements and the evolving battle conditions. In such high-stakes moments, the layout of the UI is crucial for enabling the user to act effectively without looking away from the central gameplay area. The action buttons 140 are similarly positioned to be within the natural range of finger movement, which allows the user to use action buttons 140 reflexively, perhaps to dodge, reload, or take cover to further support the need for uninterrupted visual engagement with the game environment. The array of weapon selection buttons 150 located at the bottom of the interface may represent the user's different weapons or items at the user's disposal. The user may need to glance briefly at these icons to make strategic weapon selections even during a combat.

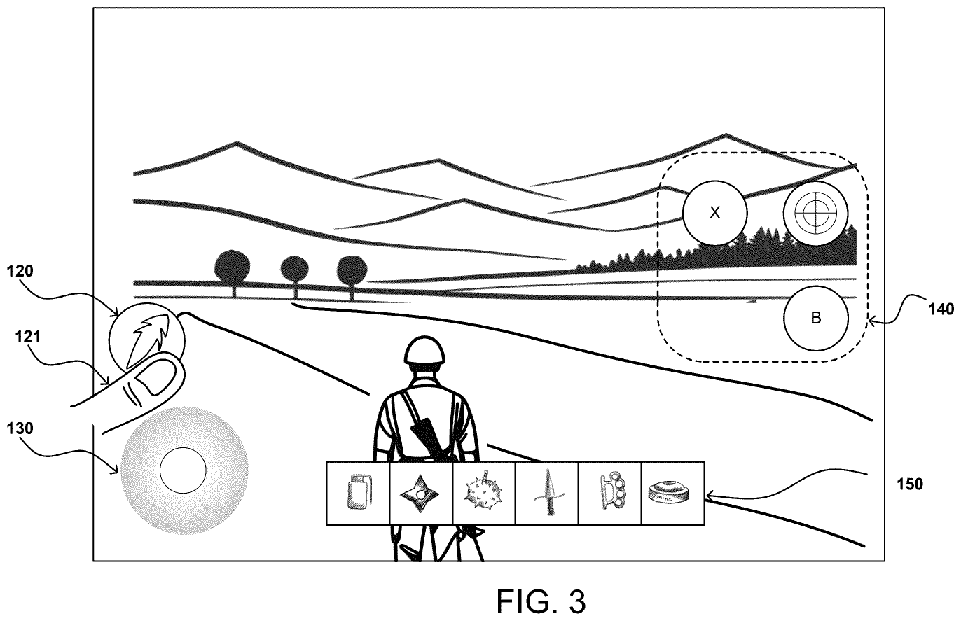

FIG. 3 continues to illustrate the dynamic interaction within the mobile gaming environment. In the example illustrated in FIG. 3, an occurrence of finger drift is demonstrated by the user's finger 121 drifting off the intended area of the fire button 120. Such an inadvertent movement may be attributed to a variety of factors such as the gradual relaxation of the user's grip, slight shifts in the device's position due to animated gameplay, or the decrease in attention as the user's engagement intensifies with the unfolding in-game action. The drift from the fire button 120 may lead to misfires or delayed responses in the heat of battle, which are critical moments where every second counts. The finger's deviation onto the screen, away from the designated control area, exemplifies the challenges faced by users during prolonged sessions where sustained focus and hand-eye coordination are crucial. As the user's finger 121 moves from its original position on the fire button 120, the user may unintentionally press an adjacent area, leading to unintended actions within the game.

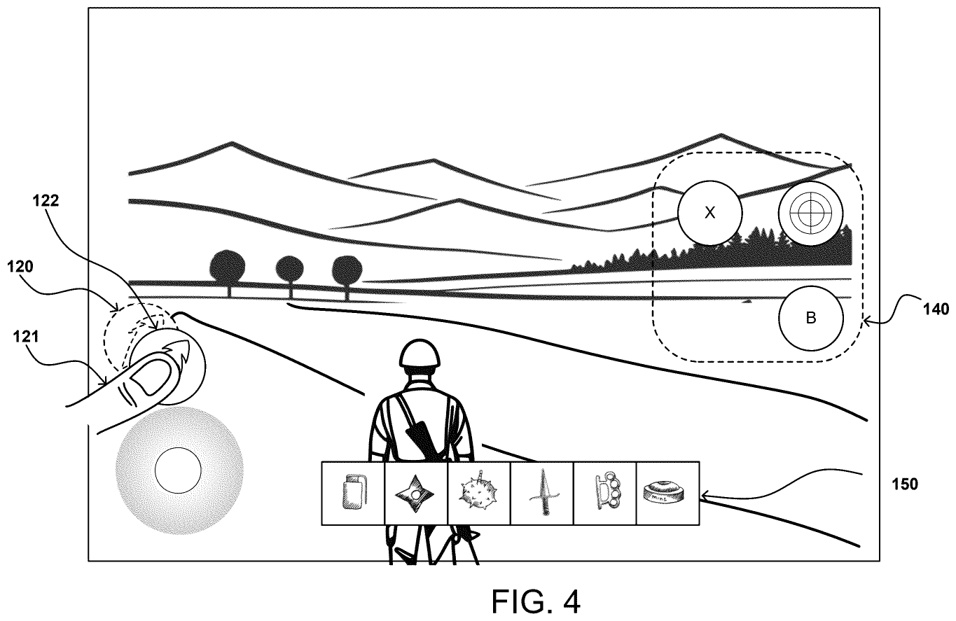

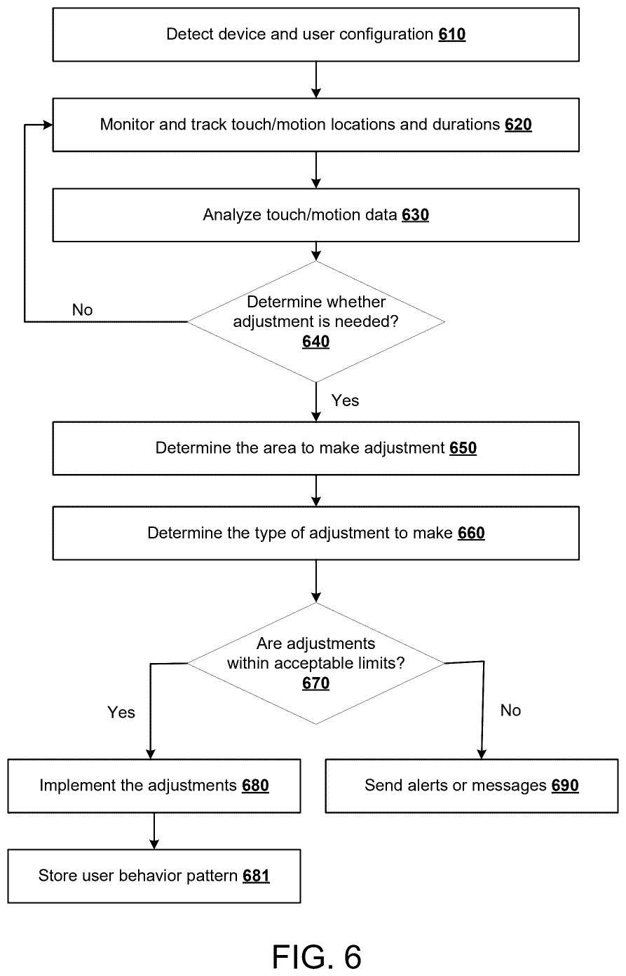

FIG. 4 presents an embodiment of a user interface enhancement that addresses the challenge of finger drift or motion drift during touch-based or motion-based interaction in a gaming environment. Finger drift may refer to the user experience where the touch point, such as a user's finger 121, inadvertently moves away from an intended button 120, such as a fire button in a mobile game. Although finger drift is illustrated as an example in FIG. 4, the drift may also include broader movement or motion drift that might occur with various gestures during gameplay. Such a motion drift may be due to the natural relaxation of the hand over time, shifts in device positioning during animated gameplay, or a decrease in attention as users become increasingly engaged in the game. As the user's finger 121 moves from its original position, it can result in misfires or delayed responses, which are particularly detrimental during critical moments of gameplay. In such situations, the dynamic UI may adjust one or more interactive areas based on the user's touch patterns to improve interaction quality. For example, as depicted in FIG. 4, the original fire button 120 is relocated to a new position 122 to better align with a calibrated area (e.g., the average area, the most recent area, etc.) where the user's finger 121 tends to drift over time. In one embodiment, such an adaptive feature may utilize heuristic analysis and/or machine learning models and leverage data such as screen size, finger size, frequency of drift, and the extent of deviation from the button's original position. In one embodiment, such adaptive adjustment may be triggered by a quantitative threshold for motion deviation. This threshold may determine the permissible range of finger/motion drift for each control element, such as the fire button 120. When the monitored touch input—or any form of gesture movement—exceeds this predefined boundary, the algorithm dynamically initiates a UI adjustment process. This adjustment may reposition the interactive element, in this case, the fire button 120, to a new calibrated position 122, which better aligns with the drift pattern observed. Details related to the process of dynamic adjustment is discussed in greater detail in accordance with FIG. 6.

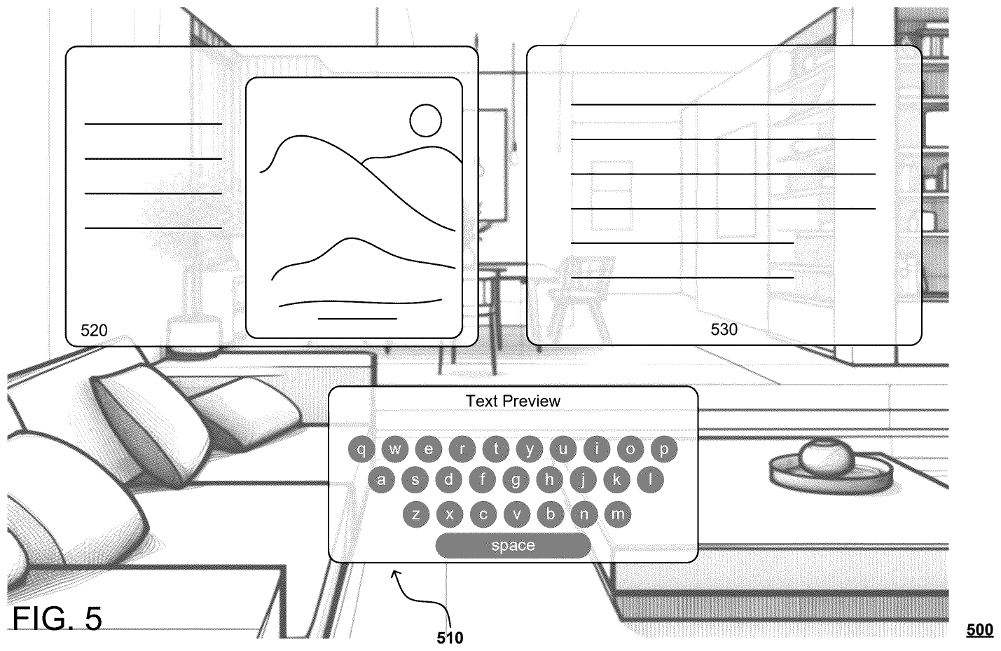

FIG. 5 illustrates an interactive virtual reality (VR) interface 500, as perceived through a head-mounted display such as the Apple Vision Pro or an Oculus device. The interface 500 depicts an example VR workspace, which may include a virtual keyboard 510 at the bottom, and multiple floating windows 520 and 530, each displaying content such as documents or images indicative of a VR environment. In VR settings, user interaction with UI elements is primarily through hand positioning and gestures, which may require the user to maintain their hands or fingers at a certain angle or in specific positions to execute actions like typing or shooting within the virtual space. As demonstrated in FIG. 5, a user may engage with the virtual keyboard 510 by aligning their hand movements to the layout of the keys for text input. Over time, fatigue or discomfort may result in a deviation from the ideal interaction posture (e.g., motion or finger drift), which may potentially lead to decreased typing accuracy or misfired actions within the VR application. To counteract the challenges presented by this ergonomic drift, dynamic adjustments may be employed to UI elements in a VR environment. The adaptive adjustment may allow for the repositioning or transformation of interactive areas, such as the virtual keyboard 510, dynamically closer to the user's new hand position or gesture orientation. The adjustment may shift the virtual keyboard's position within the user's field of view, change its orientation to match the natural rest state of the use's hands, or change the spacing of the keys to accommodate the current finger reach. Such adjustments may ensure that even as the user's optimal interaction position changes due to fatigue, the interface remains accessible and user-friendly. In one embodiment, an external camera system can be employed to monitor motion drift. For example, VR systems equipped with forward-facing cameras may monitor hand positions or user postures continuously to determine a drift pattern.

FIG. 6 illustrates an example process for dynamically adjusting an interactive UI within an application to enhance user interaction by accounting for variations in touch and motion patterns, such as finger drift. This process may be implemented on various devices with touch-sensitive displays, such as smartphones, tablets, or touch-enabled virtual reality (VR) systems. Although the process is depicted in FIG. 6 with a set number of steps, it should be understood that there may be more or fewer steps executed in varying orders, or at least partially in parallel, as well as across different systems, services, or components, within the scope of the embodiments unless specifically stated otherwise.

The process may begin with step 610, wherein a device and user configuration associated with the preference for dynamic adjustment are detected. Step 610 may include identifying the screen size of the user device, determining touch areas, and gathering user-specific data. User data, such as finger size and/or preferred touch locations, may also be incorporated into the configuration if such information is accessible from stored profiles or previous interactions. In one embodiment, a user may personalize the level of sensitivity for dynamic UI adjustments. For example, customization could be achieved through a sliding bar interface or a selection from multiple options, allowing the user to dictate the degree of sensitivity for the dynamic UI adjustment according to their individual preferences. If a high sensitivity is chosen, the UI would automatically adjust more promptly and with finer precision to minor deviations in touch patterns, whereas a lower sensitivity selection would require more substantial deviations before adjusting the UI. Furthermore, the user is offered the option to disable these adjustments entirely for a static UI regardless of touch input variability.

Continuous monitoring 620 may be performed to precisely track the locations and durations of user interactions on the touch-sensitive display or in a VR space. Such monitoring may involve recording the pixel coordinates of touch events and measuring how long each touch is maintained. In one embodiment, a pixel-based grid may be employed to detect the touch points with pixel-level accuracy, which enables the creation of a map of user interactions. The temporal data of touch events can be used in determining user's engagement level and response time. In one embodiment, a sliding time window may be used to capture a sequence of touch events over a definable period. Within this moving window, such a process may apply a centroid calculation to determine the central point of touch concentration. By analyzing the movement vectors emanating from this centroid—representing directional trends in the user's touch behavior—drift patterns can be identified such as a gradual drift away from a UI element like the fire button in a game interface.

In step 630, the gathered touch/motion data is analyzed to detect drift pattern and to determine a percentage of drift. Such analysis may leverage various metrics, including the frequency of touches within specific areas of the UI, the rate of touch drift over time, and the average distance between consecutive touches. The analysis aims to generate a comprehensive understanding of the user's touch or motion patterns and potential areas of UI misalignment. For instance, if a user's finger is consistently registering touches at a certain vectorial angle relative to the intended UI control, it may be concluded that a directional drift occurred. Further, the magnitude of drift may be calculated as a percentage of deviation from the expected position. This percentage forms a part of the criteria that establish the parameters for potential UI recalibration. In one embodiment, the velocity of the drift may be also factored in to assess whether the user's finger is moving away from the target area quickly or slowly over time, where the finger straying swiftly may indicate a lapse in concentration, and a gradual shift may suggest muscle fatigue.

Based on the analysis performed, it is determined 640 whether an adjustment to the UI is needed based on the analyzed data. In one embodiment, the determination is based on a threshold percentage of drift from the previous position (e.g., original position). If a recurring drift pattern is identified that exceeds a predefined threshold, it may be concluded that an adjustment is necessary to maintain optimal gameplay interaction. In one embodiment, other metrics may be configured to determine whether an adjustment is needed.

Upon affirming the need for an adjustment, the process may proceed to step 650 to determine the area within the UI where the adjustment should be made. This determination considers the regions of the display most affected by drift, such as movement controls or action buttons. In this step, such process may also identify which UI elements are logically grouped together and should be moved as a cohesive unit to maintain intuitive user interaction. For example, groups of action buttons like group 140 in FIGS. 1-4, often used in a sequence or requiring relative positioning due to muscle memory, are identified to move together to preserve the user's learned spatial understanding of these controls. Furthermore, some elements, such as the weapon selection buttons 150 in FIGS. 1-4, may require users to visually identify and select icons deliberately. Such elements may not subject to adjustment as they depend on visual cues rather than positional memory. Therefore, step 650 may not only involve pinpointing which area of the UI requires adjustment but also determining an appropriate grouping of elements to adjust. In one embodiment, it may also be determined that all UI elements on a user interface should be adjusted together.

After the area for adjustment is determined, a type of adjustment may be determined 660 to make to the UI. Step 660 may involve calculating the extent and direction of the drift and deciding whether to shift the position of touch areas, alter their size, or change the sensitivity of the touch recognition to better align with the detected touch patterns.

At step 670, it may be evaluated whether the proposed adjustments to the UI remain within acceptable limits, which ensures that changes are beneficial and do not impair the overall user interface design or functionality. These limits are defined to ensure that any movement of UI elements, such as touch-sensitive areas, does not exceed a maximum allowable distance. The constraint may help maintain the user's orientation and interaction consistency within the app, preventing significant shifts that could lead to confusion or errors. For example, if a joystick control is moved to correct the drift, the adjustment would be kept within a few millimeters or pixels to avoid encroaching on adjacent controls or leaving its designated interaction zone. The step 670 may also check to ensure that the adjustments do not cause any overlapping of UI elements or diminish the functionality of other components. This step may ensure that all interactive parts of the UI remain fully accessible and operational, and that visual clarity and usability are not compromised by elements becoming obscured or less responsive after adjustment.

If the adjustments are determined to be within the acceptable limits, step 680 may be performed, which involves implementing the adjustments to the UI. This implementation may take various forms, such as dynamically repositioning touch areas or changing their dimensions in real-time, to ensure the UI remains responsive to the user's touch patterns. If adjustments are made, in step 681, user behavior pattern may be stored, which may inform future adjustments and enhance the personalization of the UI.

Conversely, if the adjustments fall outside the acceptable limits, step 690 may be triggered to send alerts or messages to the user. These communications can inform the user of the identified drift and suggest manual readjustment of their touch habits or provide options to reset the UI to its default configuration.

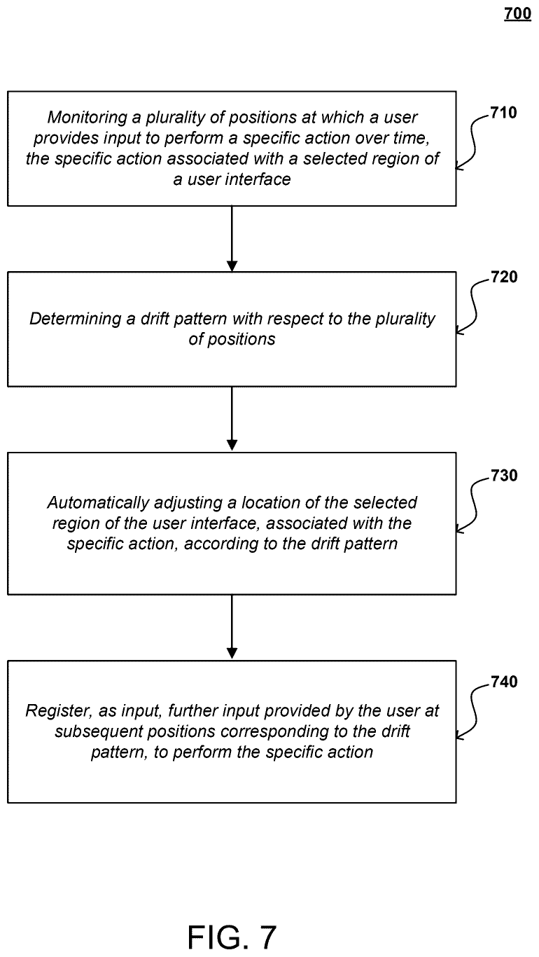

FIG. 7 illustrates an example process 700 for adapting a user interface in response to identified changes in user input patterns, specifically addressing the correction of positional drift over time. The process begins by monitoring 710 a plurality of positions at which a user provides input to perform a specific action over time. This action is associated with a selected region of a user interface, such as a virtual button or control area on a touch screen. The monitoring captures each interaction's location and create a data set that represents the user's engagement with that specific region of the user interface during gameplay. The monitored positions may be analyzed to determine 720 a drift pattern. The determination may involve identifying a consistent shift in the user's input positions away from the initial area intended for the specific action. Based on the drift pattern identified, the location of the selected region of the user interface associated with the specific action may be automatically adjusted 730. This adjustment is made to align with the user's drifted input behavior to recalibrate the user interface to correspond with the new, natural position of the user's inputs. The adjustment process is calculated and may be limited to a threshold to ensure the user interface remains intuitive and responsive to the user's touch. The process may then register 740, as input, further input provided by the user at subsequent positions corresponding to the drift pattern, to perform the specific action. The registering confirms the system's acceptance and responsiveness to user inputs at the new, adjusted position. User inputs are then continually monitored to ensure that the user interface remains aligned with the user's interaction patterns, making further adjustments as necessary.

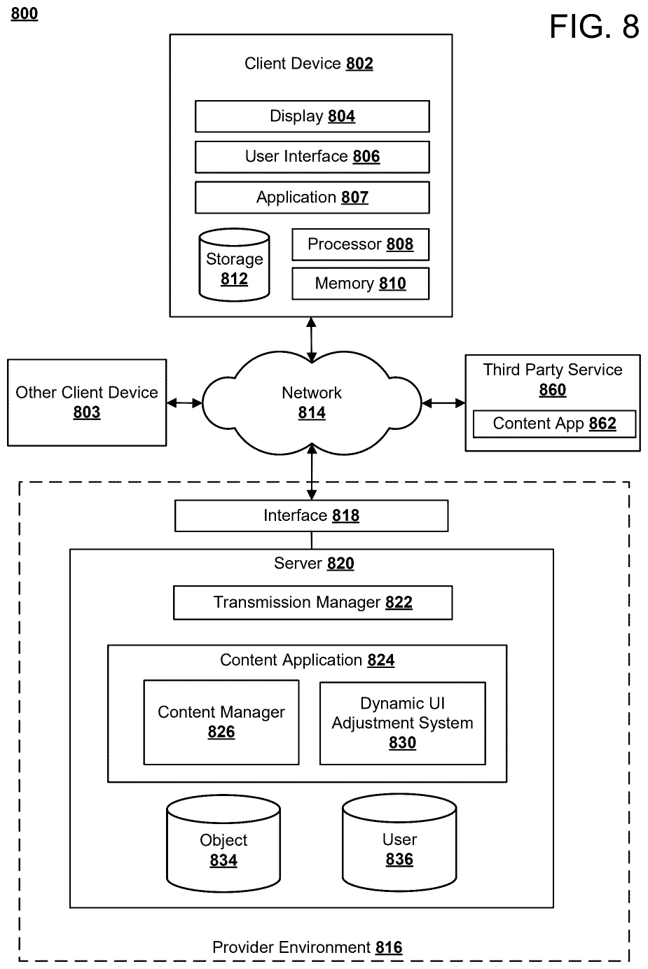

FIG. 8 illustrates an example system environment that includes a dynamic UI adjustment system, in accordance with various embodiments. As an example, FIG. 8 illustrates an example networked system 800 that can be used to provide, generate, modify, encode, process, and/or transmit data or other content. The example networked system 800 may include a client device 802, other client device 803, a network 814, a third party service 860, and a provider environment 816 that includes a dynamic UI adjustment system 830.

The client device 802 may generate or receive data for a session using components of an application 807 on client device 802 and data stored locally on that client device 802. As an example, a user may utilize a client device 802 to perform dynamic UI adjustment using the application 807. Although only one client device 802 is illustrated in detail, the example networked system 800 may include one or more other client devices 803 that can communicate with the provider environment 816 through the network 814. A client device 802 may be any appropriate computing device capable of enabling a user to perform tasks related to dynamic UI adjustment as discussed herein, such as may include a desktop computer, notebook computer, computer workstation, gaming console, set-top box, streaming device, smartphone, tablet computer, VR headset, AR goggles, wearable computer, or a smart television. In at least one embodiment, a user can access functionality related to dynamic UI adjustment using a user interface (UI) 802 running on a client device 802, although at least some functionality may also operate on a remote device, networked device, or through a cloud computing platform. In at least one embodiment, a user can provide input to the UI 806, such as through a touch-sensitive display 804 or by moving a mouse cursor displayed on a display screen. In one embodiment, a user may be able to provide inputs such as preferences and configuration data to an application 807. The application 807 may be provided by the provider environment 816 for the user to download on the client device 802. In at least one embodiment, a client device can include at least one processor 808 (e.g., a CPU or GPU), a storage 812, and a memory 810 to execute application 807 and/or perform tasks on behalf of application 807.

In one embodiment, each client device 802 can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency can be reduced by enabling the client devices to interact with servers that are in closer proximity, while also improving security of resources in the cloud provider environment.

The network 814 may represent the communication pathways among the client device 802, the provider environment 816, other client device 803, and the third party service 860. Through the network 814, the client device 802 may send input information associated with stream data processing over the network 814. The information may be received by a remote computing system, as may be part of a resource provider environment 816. In one embodiment, the network 814 is the Internet. The network 814 can include any appropriate network, including an intranet, Internet, a cellular network, a local area network (LAN), or any other such network or combination, and communication over a network can be enabled via wired and/or wireless connections. The network 814 can also utilize dedicated or private communication links that are not necessarily part of the Internet. In one embodiment, the network 814 uses standard communications technologies and/or protocols. Thus, the network 814 can include links using technologies such as Ethernet, Wi-Fi, integrated services digital network (ISDN), digital subscriber lines (DSL), asynchronous transfer mode (ATM), etc. Similarly, the networking protocols used on the network 814 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. In one embodiment, at least some of the links use mobile networking technologies, such as long term evolution (LTE). The data exchanged over the network 814 can be represented using technologies or formats including the hypertext markup language (XML), the wireless access protocol (WAP), the short message service (SMS) etc. In addition, all or some of the links can be encrypted using conventional encryption technologies such as the secure sockets layer (SSL), secure HTTP or virtual private networks (VPNs). In another embodiment, the client device 802 can use custom and/or dedicated data communications technologies instead of, or in addition to, the ones described above.

The provider environment 816 may include any appropriate components for receiving requests and returning information or performing actions in response to those requests. In the embodiment illustrated in FIG. 8, the provider environment 816 may include an interface 818, and a server 820 that include various components for performing tasks associated with dynamic UI adjustment. In at least one embodiment, the provider environment 816 might include Web servers and/or application servers for receiving and processing requests, then returning data or other content or information in response to a request.

The interface 818 may receive communications to the server 820. In at least one embodiment, the interface 818 can include application programming interfaces (APIs) or other exposed interfaces enabling a user to submit requests to the server 820. In at least one embodiment, the interface 818 can include other components as well, such as at least one Web server, routing components, or load balancers. In at least one embodiment, components of an interface 818 can determine a type of request or communication, and can direct a request to an appropriate system or service such as a dynamic UI adjustment system 830.

The server 820 may include a transmission manager 822, a content application 824, an object repository 834, and a user database 836. The server 820 may receive requests and data from the client device 802, perform tasks associated with the requests, and send results or other data to the client device 802. In at least one embodiment, a content application 824 executing on the server 820 (e.g., a cloud server or edge server) may initiate a session associated with the client device 802, as may use a session manager and user data stored in a user database 836, and can cause content such as one or more object representations from an object repository 834 to be selected by a content manager 826 for processing. At least a portion of the generated content, such as results from stream data processing may be transmitted to the client device 802 using an appropriate transmission manager 822 to send by download, streaming, or another such transmission channel. An encoder may be used to encode and/or compress at least some of this data before transmitting to the client device 802. In at least one embodiment, the client device 802 receiving such content can provide this content to a corresponding application 807 for selecting, providing, synthesizing, modifying, or using content for presentation (or other purposes) on or by the client device 802. A decoder may also be used to decode data received over the network 814 for presentation via client device 802, such as image or video content through a touch-sensitive display 804. In at least one embodiment, at least some of the content may already be stored on, rendered on, or accessible to client device 802 such that transmission over the network 814 is not required for at least that portion of content, such as where the content may have been previously downloaded or stored locally on a hard drive or optical disk. In at least one embodiment, a transmission mechanism such as data streaming can be used to transfer the content from the server 820, or user database 836, to client device 802. In at least one embodiment, at least a portion of this content can be obtained, enhanced, and/or streamed from another source, such as a third party service 860 or other client device 803, that may also include a content application 862 for generating, enhancing, or providing content. In at least one embodiment, portions of this functionality can be performed using multiple computing devices, or multiple processors within one or more computing devices, such as may include a combination of CPUs and GPUs.

In at least one embodiment, the server 820 may include a processor such as a central processing unit (CPU). In at least one embodiment, however, resources in such environments can utilize GPUs to process data for at least certain types of requests. In at least one embodiment, with thousands of cores, GPUs are designed to handle substantial parallel workloads and, therefore, have become popular in deep learning for training neural networks and generating predictions. In at least one embodiment, while use of GPUs for offline builds has enabled faster training of larger and more complex models, generating predictions offline implies that either request-time input features cannot be used or predictions must be generated for all permutations of features and stored in a lookup table to serve real-time requests. In at least one embodiment, if a deep learning framework supports a CPU-mode and a model is small and simple enough to perform a feed-forward on a CPU with a reasonable latency, then a service on a CPU instance could host a model. In at least one embodiment, training can be done offline on a GPU and inference done in real-time on a CPU. In at least one embodiment, if a CPU approach is not a viable option, then a service can run on a GPU instance. In at least one embodiment, because GPUs have different performance and cost characteristics than CPUs, however, running a service that offloads a runtime algorithm to a GPU can require it to be designed differently from a CPU based service.

The server 820 may include a content application 824 that includes a content manager 826 and a dynamic UI adjustment system 830. As discussed previously, the content manager 826 may send objects, such as datasets and instructions, from the object repository 834 along with requests and other data from the client device 802 to a dynamic UI adjustment system 830 for stream data processing. A dynamic UI adjustment system 830 may process input data and provide the results to the transmission manager 822 for sending back to the client device 802. A dynamic UI adjustment system 830 may also use local datasets or datasets provided by the third party service 860 for stream data processing.

### Inference and Training Logic

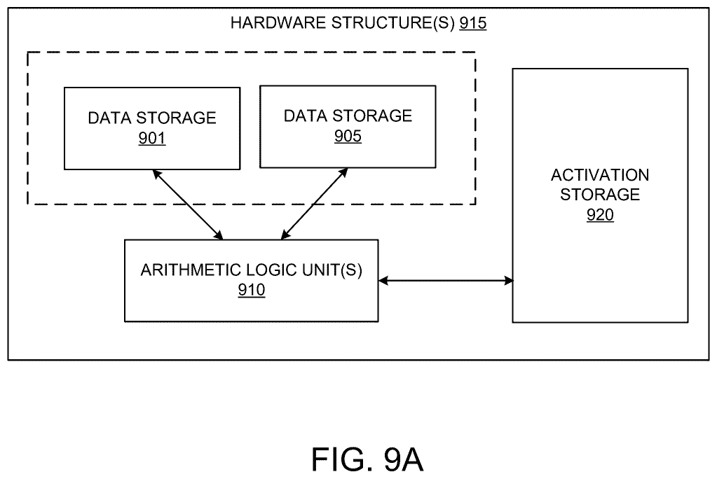

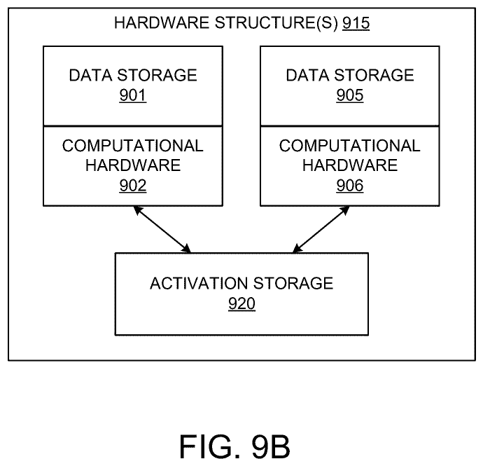

FIG. 9A illustrates inference and/or training logic 915 used to perform inferencing and/or training operations associated with one or more embodiments. Details regarding inference and/or training logic 915 are provided below in conjunction with FIGS. 9A and/or 9B.

In at least one embodiment, inference and/or training logic 915 may include, without limitation, code and/or data storage 901 to store forward and/or output weight and/or input/output data, and/or other parameters to configure neurons or layers of a neural network trained and/or used for inferencing in aspects of one or more embodiments. In at least one embodiment, training logic 915 may include, or be coupled to code and/or data storage 901 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 901 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 901 may be included with other on-chip or off-chip data storage, including a processor's L1, L2, or L3 cache or system memory.

In at least one embodiment, any portion of code and/or data storage 901 may be internal or external to one or more processors or other hardware logic devices or circuits. In at least one embodiment, code and/or data storage 901 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 901 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 may include, without limitation, a code and/or data storage 905 to store backward and/or output weight and/or input/output data corresponding to neurons or layers of a neural network trained and/or used for inferencing in aspects of one or more embodiments. In at least one embodiment, code and/or data storage 905 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 915 may include, or be coupled to code and/or data storage 905 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 905 may be included with other on-chip or off-chip data storage, including a processor's L1, L2, or L3 cache or system memory. In at least one embodiment, any portion of code and/or data storage 905 may be internal or external to on one or more processors or other hardware logic devices or circuits. In at least one embodiment, code and/or data storage 905 may be cache memory, DRAM, SRAM, non-volatile memory (e.g., Flash memory), or other storage. In at least one embodiment, choice of whether code and/or data storage 905 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 901 and code and/or data storage 905 may be separate storage structures. In at least one embodiment, code and/or data storage 901 and code and/or data storage 905 may be same storage structure. In at least one embodiment, code and/or data storage 901 and code and/or data storage 905 may be partially same storage structure and partially separate storage structures. In at least one embodiment, any portion of code and/or data storage 901 and code and/or data storage 905 may be included with other on-chip or off-chip data storage, including a processor's L1, L2, or L3 cache or system memory.

In at least one embodiment, inference and/or training logic 915 may include, without limitation, one or more arithmetic logic unit(s) (“ALU(s)”) 910, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 920 that are functions of input/output and/or weight parameter data stored in code and/or data storage 901 and/or code and/or data storage 905. In at least one embodiment, activations stored in activation storage 920 are generated according to linear algebraic and or matrix-based mathematics performed by ALU(s) 910 in response to performing instructions or other code, wherein weight values stored in code and/or data storage 901 and/or code and/or data storage 905 are used as operands along with other values, such as bias values, gradient information, momentum values, or other parameters or hyperparameters, any or all of which may be stored in code and/or data storage 901 or code and/or data storage 905 or another storage on or off-chip.

In at least one embodiment, ALU(s) 910 are included within one or more processors or other hardware logic devices or circuits, whereas in another embodiment, ALU(s) 910 may be external to a processor or other hardware logic device or circuit that uses them (e.g., a co-processor). In at least one embodiment, ALU(s) 910 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 901, code and/or data storage 905, and activation storage 920 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 920 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 920 may be cache memory, DRAM, SRAM, non-volatile memory (e.g., Flash memory), or other storage. In at least one embodiment, activation storage 920 may be completely or partially within or external to one or more processors or other logical circuits. In at least one embodiment, choice of whether activation storage 920 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 915 illustrated in FIG. 9A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9A may be used in conjunction with central processing unit (“CPU”) hardware, graphics processing unit (“GPU”) hardware or other hardware, such as field programmable gate arrays (“FPGAs”).

FIG. 9B illustrates inference and/or training logic 915, according to at least one or more embodiments. In at least one embodiment, inference and/or training logic 915 may include, without limitation, hardware logic in which computational resources are dedicated or otherwise exclusively used in conjunction with weight values or other information corresponding to one or more layers of neurons within a neural network. In at least one embodiment, inference and/or training logic 915 illustrated in FIG. 9B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9B may be used in conjunction with central processing unit (CPU) hardware, graphics processing unit (GPU) hardware or other hardware, such as field programmable gate arrays (FPGAs). In at least one embodiment, inference and/or training logic 915 includes, without limitation, code and/or data storage 901 and code and/or data storage 905, which may be used to store code (e.g., graph code), weight values and/or other information, including bias values, gradient information, momentum values, and/or other parameter or hyperparameter information. In at least one embodiment illustrated in FIG. 9B, each of code and/or data storage 901 and code and/or data storage 905 is associated with a dedicated computational resource, such as computational hardware 902 and computational hardware 906, respectively. In at least one embodiment, each of computational hardware 902 and computational hardware 906 comprises one or more ALUs that perform mathematical functions, such as linear algebraic functions, only on information stored in code and/or data storage 901 and code and/or data storage 905, respectively, result of which is stored in activation storage 920.

In at least one embodiment, each of code and/or data storage 901 and 905 and corresponding computational hardware 902 and 906, respectively, correspond to different layers of a neural network, such that resulting activation from one “storage/computational pair 901/902” of code and/or data storage 901 and computational hardware 902 is provided as an input to “storage/computational pair 905/906” of code and/or data storage 905 and computational hardware 906, in order to mirror conceptual organization of a neural network. In at least one embodiment, each of storage/computational pairs 901/902 and 905/906 may correspond to more than one neural network layer. In at least one embodiment, additional storage/computation pairs (not shown) subsequent to or in parallel with storage computation pairs 901/902 and 905/906 may be included in inference and/or training logic 915.

### Data Center

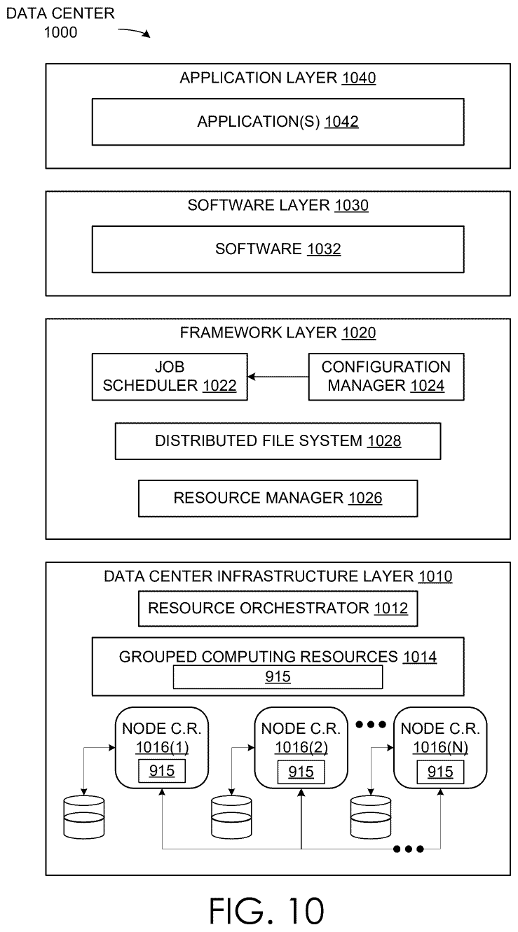

FIG. 10 illustrates an example data center 1000, in which at least one embodiment may be used. In at least one embodiment, data center 1000 includes a data center infrastructure layer 1010, a framework layer 1020, a software layer 1030, and an application layer 1040.

In at least one embodiment, as shown in FIG. 10, data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in data centers at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1012 may configure or otherwise control one or more node C.R.s 1016(1)-1016(N) and/or grouped computing resources 1014. In at least one embodiment, resource orchestrator 1012 may include a software design infrastructure (“SDI”) management entity for data center 1000. In at least one embodiment, resource orchestrator 1012 may include hardware, software or some combination thereof.

In at least one embodiment, as shown in FIG. 10, framework layer 1020 includes a job scheduler 1022, a configuration manager 1024, a resource manager 1026 and a distributed file system 1028. In at least one embodiment, framework layer 1020 may include a framework to support software 1032 of software layer 1030 and/or one or more application(s) 1042 of application layer 1040. In at least one embodiment, software 1032 or application(s) 1042 may respectively include web-based service software or applications, such as those provided by Amazon Web Services, Google Cloud and Microsoft Azure. In at least one embodiment, framework layer 1020 may be, but is not limited to, a type of free and open-source software web application framework such as Apache Spark™ (hereinafter “Spark”) that may use distributed file system 1028 for large-scale data processing (e.g., “big data”). In at least one embodiment, job scheduler 1022 may include a Spark driver to facilitate scheduling of workloads supported by various layers of data center 1000. In at least one embodiment, configuration manager 1024 may be capable of configuring different layers such as software layer 1030 and framework layer 1020 including Spark and distributed file system 1028 for supporting large-scale data processing. In at least one embodiment, resource manager 1026 may be capable of managing clustered or grouped computing resources mapped to or allocated for support of distributed file system 1028 and job scheduler 1022. In at least one embodiment, clustered or grouped computing resources may include grouped computing resource 1014 at data center infrastructure layer 1010. In at least one embodiment, resource manager 1026 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1028 of framework layer 1020. The one or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1028 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1024, resource manager 1026, and resource orchestrator 1012 may implement any number and type of self-modifying actions based on any amount and type of data acquired in any technically feasible fashion. In at least one embodiment, self-modifying actions may relieve a data center operator of data center 1000 from making possibly bad configuration decisions and possibly avoiding underused and/or poor performing portions of a data center.

In at least one embodiment, data center 1000 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1000. In at least one embodiment, trained machine learning models corresponding to one or more neural networks may be used to infer or predict information using resources described above with respect to data center 1000 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 915 are used to perform inferencing and/or training operations associated with one or more embodiments. Details regarding inference and/or training logic 915 are provided below in conjunction with FIGS. 9A and/or 9B. In at least one embodiment, inference and/or training logic 915 may be used in system FIG. 10 for inferencing or predicting operations based, at least in part, on weight parameters calculated using neural network training operations, neural network functions and/or architectures, or neural network use cases described herein.

Such components presented herein can allow for improving the PSRR to identify and correct voltage noise within a circuit.

### Computer Systems

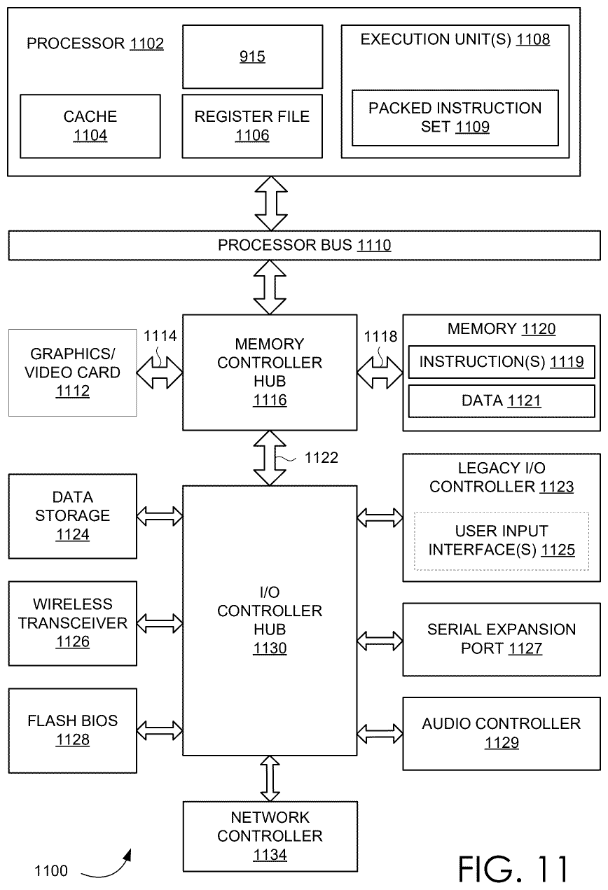

FIG. 11 is a block diagram illustrating an exemplary computer system 1100, which may be a system with interconnected devices and components, a system-on-a-chip (SOC) or some combination thereof formed with a processor that may include execution units to execute an instruction, according to at least one embodiment. In at least one embodiment, computer system 1100 may include, without limitation, a component, such as a processor 1102 to employ execution units including logic to perform algorithms for process data, in accordance with present disclosure, such as in embodiment described herein. In at least one embodiment, computer system 1100 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1100 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1100 may include, without limitation, processor 1102 that may include, without limitation, one or more execution unit(s) 1108 to perform machine learning model training and/or inferencing according to techniques described herein. In at least one embodiment, computer system 1100 is a single processor desktop or server system, but in another embodiment computer system 1100 may be a multiprocessor system. In at least one embodiment, processor 1102 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 1102 may be coupled to a processor bus 1110 that may transmit data signals between processor 1102 and other components in computer system 1100.

In at least one embodiment, processor 1102 may include, without limitation, a Level 1 (“L1”) internal cache memory (“cache”) 1104. In at least one embodiment, processor 1102 may have a single internal cache or multiple levels of internal cache. In at least one embodiment, cache 1104 may reside external to processor 1102. Other embodiments may also include a combination of both internal and external caches depending on particular implementation and needs. In at least one embodiment, register file 1106 may store different types of data in various registers including, without limitation, integer registers, floating point registers, status registers, and instruction pointer register.

In at least one embodiment, execution unit(s) 1108, including, without limitation, logic to perform integer and floating point operations, also resides in processor 1102. In at least one embodiment, processor 1102 may also include a microcode (“ucode”) read only memory (“ROM”) that stores microcode for certain macro instructions. In at least one embodiment, execution unit(s) 1108 may include logic to handle a packed instruction set 1109. In at least one embodiment, by including packed instruction set 1109 in an instruction set of a general-purpose processor 1102, along with associated circuitry to execute instructions, operations used by many multimedia applications may be performed using packed data in a general-purpose processor 1102. In one or more embodiments, many multimedia applications may be accelerated and executed more efficiently by using full width of a processor data bus 1110 for performing operations on packed data, which may eliminate need to transfer smaller units of data across processor data bus 1110 to perform one or more operations one data element at a time.

In at least one embodiment, execution unit(s) 1108 may also be used in microcontrollers, embedded processors, graphics devices, DSPs, and other types of logic circuits. In at least one embodiment, computer system 1100 may include, without limitation, a memory 1120. In at least one embodiment, memory 1120 may be implemented as a Dynamic Random Access Memory (“DRAM”) device, a Static Random Access Memory (“SRAM”) device, flash memory device, or other memory device. In at least one embodiment, memory 1120 may store instruction(s) 1119 and/or data 1121 represented by data signals that may be executed by processor 1102.

In at least one embodiment, system logic chip may be coupled to processor bus 1110 and memory 1120. In at least one embodiment, system logic chip may include, without limitation, a memory controller hub (“MCH”) 1116, and processor 1102 may communicate with MCH 1116 via processor bus 1110. In at least one embodiment, MCH 1116 may provide a high bandwidth memory path 1118 to memory 1120 for instruction and data storage and for storage of graphics commands, data and textures. In at least one embodiment, MCH 1116 may direct data signals between processor 1102, memory 1120, and other components in computer system 1100 and to bridge data signals between processor bus 1110, memory 1120, and a system I/O 1122. In at least one embodiment, system logic chip may provide a graphics port for coupling to a graphics controller. In at least one embodiment, MCH 1116 may be coupled to memory 1120 through a high bandwidth memory path 1118 and graphics/video card 1112 may be coupled to MCH 1116 through an Accelerated Graphics Port (“AGP”) interconnect 1114.

In at least one embodiment, computer system 1100 may use system I/O 1122 that is a proprietary hub interface bus to couple MCH 1116 to I/O controller hub (“ICH”) 1130. In at least one embodiment, ICH 1130 may provide direct connections to some I/O devices via a local I/O bus. In at least one embodiment, local I/O bus may include, without limitation, a high-speed I/O bus for connecting peripherals to memory 1120, chipset, and processor 1102. Examples may include, without limitation, an audio controller 1129, a firmware hub (“flash BIOS”) 1128, a wireless transceiver 1126, a data storage 1124, a legacy I/O controller 1123 containing user input and keyboard interface(s) 1125, a serial expansion port 1127, such as Universal Serial Bus (“USB”), and a network controller 1134. Data storage 1124 may comprise a hard disk drive, a floppy disk drive, a CD-ROM device, a flash memory device, or other mass storage device.

In at least one embodiment, FIG. 11 illustrates a system, which includes interconnected hardware devices or “chips”, whereas in other embodiments, FIG. 11 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 915 are used to perform inferencing and/or training operations associated with one or more embodiments. Details regarding inference and/or training logic 915 are provided below in conjunction with FIGS. 9A and/or 9B. In at least one embodiment, inference and/or training logic 915 may be used in system FIG. 11 for inferencing or predicting operations based, at least in part, on weight parameters calculated using neural network training operations, neural network functions and/or architectures, or neural network use cases described herein.

Such components presented herein can allow for improving the PSRR to identify and correct voltage noise within a circuit.

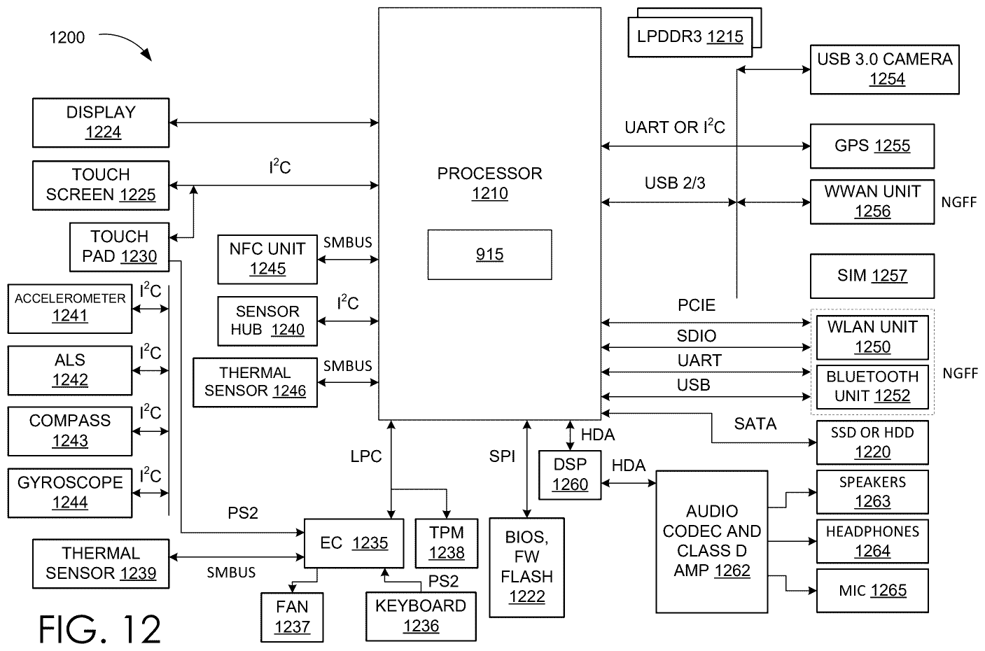

FIG. 12 is a block diagram illustrating an electronic device 1200 for using a processor 1210, according to at least one embodiment. In at least one embodiment, electronic device 1200 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1200 may include, without limitation, processor 1210 communicatively coupled to any suitable number or kind of components, peripherals, modules, or devices. In at least one embodiment, processor 1210 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 12 illustrates an electronic device 1200, which includes interconnected hardware devices or “chips”, whereas in other embodiments, FIG. 12 may illustrate an exemplary System on a Chip (“SoC”). In at least one embodiment, devices illustrated in FIG. 12 may be interconnected with proprietary interconnects, standardized interconnects (e.g., PCIe) or some combination thereof. In at least one embodiment, one or more components of FIG. 12 are interconnected using compute express link (CXL) interconnects.

In at least one embodiment, FIG. 12 may include a display 1224, a touch screen 1225, a touch pad 1230, a Near Field Communications unit (“NFC”) 1245, a sensor hub 1240, a thermal sensor 1246, an Express Chipset (“EC”) 1235, a Trusted Platform Module (“TPM”) 1238, BIOS/firmware/flash memory (“BIOS, FW Flash”) 1222, a DSP 1260, a drive 1220 such as a Solid State Disk (“SSD”) or a Hard Disk Drive (“HDD”), a wireless local area network unit (“WLAN”) 1250, a Bluetooth unit 1252, a Wireless Wide Area Network unit (“WWAN”) 1256, a Global Positioning System (GPS) 1255, a camera (“USB 3.0 camera”) 1254 such as a USB 3.0 camera, and/or a Low Power Double Data Rate (“LPDDR”) memory unit (“LPDDR3”) 1215 implemented in, for example, LPDDR3 standard. These components may each be implemented in any suitable manner.

In at least one embodiment, other components may be communicatively coupled to processor 1210 through components discussed above. In at least one embodiment, an accelerometer 1241, Ambient Light Sensor (“ALS”) 1242, compass 1243, and a gyroscope 1244 may be communicatively coupled to sensor hub 1240. In at least one embodiment, thermal sensor 1239, a fan 1237, a keyboard 1236, and a touch pad 1230 may be communicatively coupled to EC 1235. In at least one embodiment, speakers 1263, headphones 1264, and microphone (“mic”) 1265 may be communicatively coupled to an audio unit (“audio codec and class d amp”) 1262, which may in turn be communicatively coupled to DSP 1260. In at least one embodiment, audio unit 1262 may include, for example and without limitation, an audio coder/decoder (“codec”) and a class D amplifier. In at least one embodiment, SIM card (“SIM”) 1257 may be communicatively coupled to WWAN unit 1256. In at least one embodiment, components such as WLAN unit 1050 and Bluetooth unit 1252, as well as WWAN unit 1256 may be implemented in a Next Generation Form Factor (“NGFF”).

Inference and/or training logic 915 are used to perform inferencing and/or training operations associated with one or more embodiments. Details regarding inference and/or training logic 915 are provided below in conjunction with FIGS. 9A and/or 9B. In at least one embodiment, inference and/or training logic 915 may be used in system FIG. 12 for inferencing or predicting operations based, at least in part, on weight parameters calculated using neural network training operations, neural network functions and/or architectures, or neural network use cases described herein.

Such components presented herein can allow for improving the PSRR to identify and correct voltage noise within a circuit.

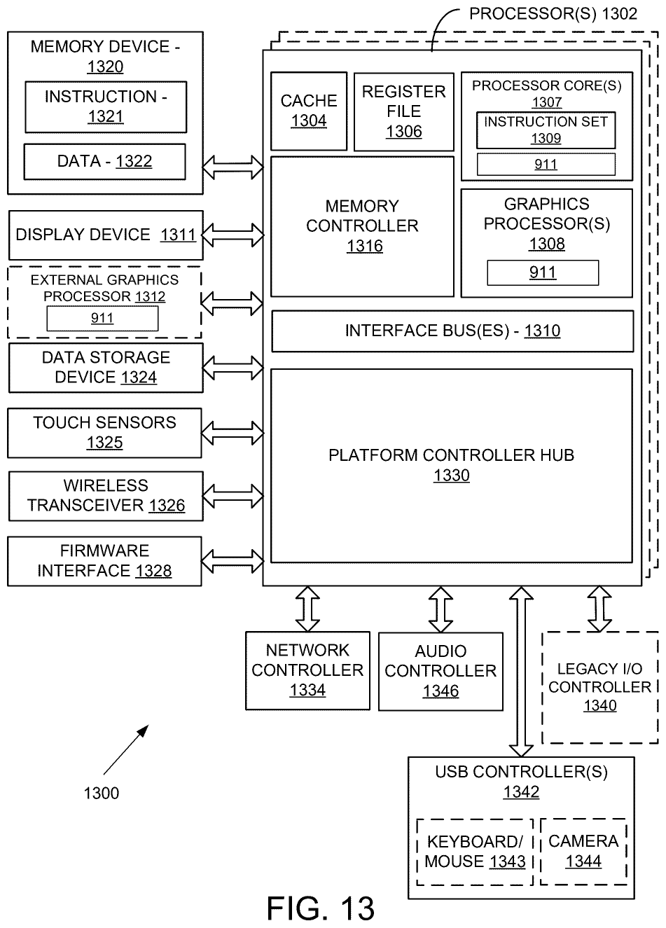

FIG. 13 is a block diagram of a processing system, according to at least one embodiment. In at least one embodiment, processing system 1300 includes one or more processor(s) 1302 and one or more graphics processor(s) 1308, and may be a single processor desktop system, a multiprocessor workstation system, or a server system having a large number of processor(s) 1302 or processor core(s) 1307. In at least one embodiment, processing system 1300 is a processing platform incorporated within a system-on-a-chip (SoC) integrated circuit for use in mobile, handheld, or embedded devices.

In at least one embodiment, processing system 1300 can include, or be incorporated within a server-based gaming platform, a game console, including a game and media console, a mobile gaming console, a handheld game console, or an online game console. In at least one embodiment, processing system 1300 is a mobile phone, smart phone, tablet computing device or mobile Internet device. In at least one embodiment, processing system 1300 can also include, coupled with, or be integrated within a wearable device, such as a smart watch wearable device, smart eyewear device, augmented reality device, or virtual reality device. In at least one embodiment, processing system 1300 is a television or set top box device having one or more processor(s) 1302 and a graphical interface generated by one or more graphics processor(s) 1308.

In at least one embodiment, one or more processor(s) 1302 each include one or more processor core(s) 1307 to process instructions which, when executed, perform operations for system and user software. In at least one embodiment, each of one or more processor core(s) 1307 is configured to process a specific instruction set 1309. In at least one embodiment, instruction set 1309 may facilitate Complex Instruction Set Computing (CISC), Reduced Instruction Set Computing (RISC), or computing via a Very Long Instruction Word (VLIW). In at least one embodiment, processor core(s) 1307 may each process a different instruction set 1309, which may include instructions to facilitate emulation of other instruction sets. In at least one embodiment, processor core(s) 1307 may also include other processing devices, such a Digital Signal Processor (DSP).

In at least one embodiment, processor(s) 1302 includes cache memory (“cache”) 1304. In at least one embodiment, processor(s) 1302 can have a single internal cache or multiple levels of internal cache. In at least one embodiment, cache 1304 is shared among various components of processor(s) 1302. In at least one embodiment, processor(s) 1302 also uses an external cache (e.g., a Level-3 (L3) cache or Last Level Cache (LLC)) (not shown), which may be shared among processor core(s) 1307 using known cache coherency techniques. In at least one embodiment, register file 1306 is additionally included in processor(s) 1302 which may include different types of registers for storing different types of data (e.g., integer registers, floating point registers, status registers, and an instruction pointer register). In at least one embodiment, register file 1306 may include general-purpose registers or other registers.

In at least one embodiment, one or more processor(s) 1302 are coupled with one or more interface bus(es) 1310 to transmit communication signals such as address, data, or control signals between processor(s) 1302 and other components in processing system 1300. In at least one embodiment, interface bus(es) 1310, in one embodiment, can be a processor bus, such as a version of a Direct Media Interface (DMI) bus. In at least one embodiment, interface bus(es) 1310 is not limited to a DMI bus, and may include one or more Peripheral Component Interconnect buses (e.g., PCI, PCI Express), memory buses, or other types of interface buses. In at least one embodiment processor(s) 1302 include an integrated memory controller 1316 and a platform controller hub 1330. In at least one embodiment, memory controller 1316 facilitates communication between a memory device 1320 and other components of processing system 1300, while platform controller hub (PCH) 1330 provides connections to I/O devices via a local I/O bus.

In at least one embodiment, memory device 1320 can be a dynamic random access memory (DRAM) device, a static random access memory (SRAM) device, flash memory device, phase-change memory device, or some other memory device having suitable performance to serve as process memory. In at least one embodiment memory device 1320 can operate as system memory for processing system 1300, to store data 1322 and instruction 1321 for use when one or more processor(s) 1302 executes an application or process. In at least one embodiment, memory controller 1316 also couples with an optional external graphics processor 1312, which may communicate with one or more graphics processor(s) 1308 in processor(s) 1302 to perform graphics and media operations. In at least one embodiment, a display device 1311 can connect to processor(s) 1302. In at least one embodiment display device 1311 can include one or more of an internal display device, as in a mobile electronic device or a laptop device or an external display device attached via a display interface (e.g., DisplayPort, etc.). In at least one embodiment, display device 1311 can include a head mounted display (HMD) such as a stereoscopic display device for use in virtual reality (VR) applications or augmented reality (AR) applications.

In at least one embodiment, platform controller hub 1330 allows peripherals to connect to memory device 1320 and processor(s) 1302 via a high-speed I/O bus. In at least one embodiment, I/O peripherals include, but are not limited to, an audio controller 1346, a network controller 1334, a firmware interface 1328, a wireless transceiver 1326, touch sensors 1325, a data storage device 1324 (e.g., hard disk drive, flash memory, etc.). In at least one embodiment, data storage device 1324 can connect via a storage interface (e.g., SATA) or via a peripheral bus, such as a Peripheral Component Interconnect bus (e.g., PCI, PCI Express). In at least one embodiment, touch sensors 1325 can include touch screen sensors, pressure sensors, or fingerprint sensors. In at least one embodiment, wireless transceiver 1326 can be a Wi-Fi transceiver, a Bluetooth transceiver, or a mobile network transceiver such as a 3G, 4G, or Long Term Evolution (LTE) transceiver. In at least one embodiment, firmware interface 1328 allows communication with system firmware, and can be, for example, a unified extensible firmware interface (UEFI). In at least one embodiment, network controller 1334 can allow a network connection to a wired network. In at least one embodiment, a high-performance network controller (not shown) couples with interface bus(es) 1310. In at least one embodiment, audio controller 1346 is a multi-channel high definition audio controller. In at least one embodiment, processing system 1300 includes an optional legacy I/O controller 1340 for coupling legacy (e.g., Personal System 2 (PS/2)) devices to system. In at least one embodiment, platform controller hub 1330 can also connect to one or more Universal Serial Bus (USB) controller(s) 1342 connect input devices, such as keyboard and mouse 1343 combinations, a camera 1344, or other USB input devices.

In at least one embodiment, an instance of memory controller 1316 and platform controller hub 1330 may be integrated into a discreet external graphics processor, such as external graphics processor 1312. In at least one embodiment, platform controller hub 1330 and/or memory controller 1316 may be external to one or more processor(s) 1302. For example, in at least one embodiment, processing system 1300 can include an external memory controller 1316 and platform controller hub 1330, which may be configured as a memory controller hub and peripheral controller hub within a system chipset that is in communication with processor(s) 1302.

Inference and/or training logic 915 are used to perform inferencing and/or training operations associated with one or more embodiments. Details regarding inference and/or training logic 915 are provided below in conjunction with FIGS. 9A and/or 9B. In at least one embodiment portions or all of inference and/or training logic 915 may be incorporated into processing system 1300. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 9A and/or 9B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components presented herein can allow for improving the PSRR to identify and correct voltage noise within a circuit.

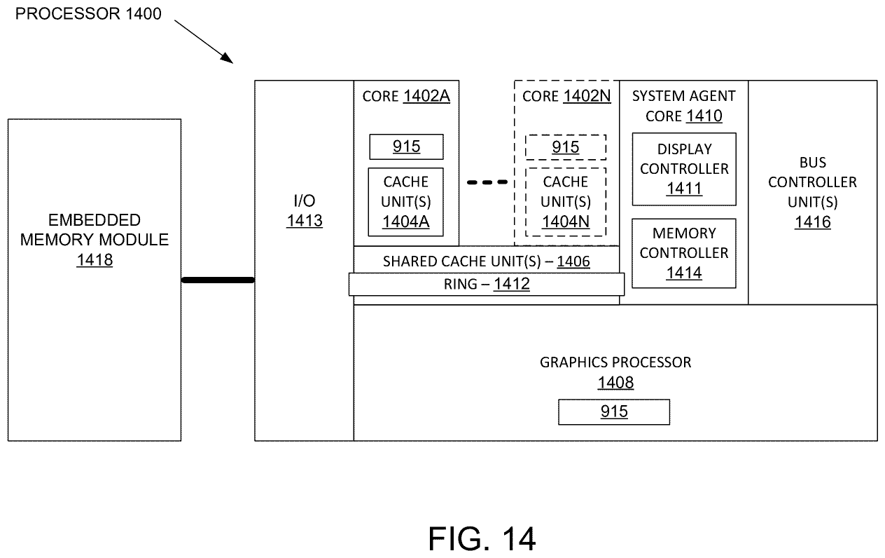

FIG. 14 is a block diagram of a processor 1400 having one or more processor core(s) 1402A-1402N, an integrated memory controller 1414, and an integrated graphics processor 1408, according to at least one embodiment. In at least one embodiment, processor 1400 can include additional cores up to and including additional core(s) 1402N represented by dashed lined boxes. In at least one embodiment, each of processor core(s) 1402A-1402N includes one or more internal cache unit(s) 1404A-1404N. In at least one embodiment, each processor core also has access to one or more shared cached unit(s) 1406.

In at least one embodiment, internal cache unit(s) 1404A-1404N and shared cache unit(s) 1406 represent a cache memory hierarchy within processor 1400. In at least one embodiment, cache memory unit(s) 1404A-1404N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1406 and 1404A-1404N.

In at least one embodiment, processor 1400 may also include a set of one or more bus controller unit(s) 1416 and a system agent core 1410. In at least one embodiment, one or more bus controller unit(s) 1416 manage a set of peripheral buses, such as one or more PCI or PCI express buses. In at least one embodiment, system agent core 1410 provides management functionality for various processor components. In at least one embodiment, system agent core 1410 includes one or more integrated memory controller(s) 1414 to manage access to various external memory devices (not shown).

In at least one embodiment, one or more of processor core(s) 1402A-1402N include support for simultaneous multi-threading. In at least one embodiment, system agent core 1410 includes components for coordinating and processor core(s) 1402A-1402N during multi-threaded processing. In at least one embodiment, system agent core 1410 may additionally include a power control unit (PCU), which includes logic and components to regulate one or more power states of processor core(s) 1402A-1402N and graphics processor 1408.

In at least one embodiment, processor 1400 additionally includes graphics processor 1408 to execute graphics processing operations. In at least one embodiment, graphics processor 1408 couples with shared cache unit(s) 1406, and system agent core 1410, including one or more integrated memory controller(s) 1414. In at least one embodiment, system agent core 1410 also includes a display controller 1411 to drive graphics processor output to one or more coupled displays. In at least one embodiment, display controller 1411 may also be a separate module coupled with graphics processor 1408 via at least one interconnect, or may be integrated within graphics processor 1408.

In at least one embodiment, a ring based interconnect unit 1412 is used to couple internal components of processor 1400. In at least one embodiment, an alternative interconnect unit may be used, such as a point-to-point interconnect, a switched interconnect, or other techniques. In at least one embodiment, graphics processor 1408 couples with ring based interconnect unit 1412 via an I/O link 1413.

In at least one embodiment, I/O link 1413 represents at least one of multiple varieties of I/O interconnects, including an on package I/O interconnect which facilitates communication between various processor components and a high-performance embedded memory module 1418, such as an eDRAM module. In at least one embodiment, each of processor core(s) 1402A-1402N and graphics processor 1208 use embedded memory module 1418 as a shared Last Level Cache.

In at least one embodiment, processor core(s) 1402A-1402N are homogenous cores executing a common instruction set architecture. In at least one embodiment, processor core(s) 1402A-1402N are heterogeneous in terms of instruction set architecture (ISA), where one or more of processor core(s) 1402A-1402N execute a common instruction set, while one or more other cores of processor core(s) 1402A-1402N executes a subset of a common instruction set or a different instruction set. In at least one embodiment, processor core(s) 1402A-1402N are heterogeneous in terms of microarchitecture, where one or more cores having a relatively higher power consumption couple with one or more power cores having a lower power consumption. In at least one embodiment, processor 1400 can be implemented on one or more chips or as an SoC integrated circuit.

Inference and/or training logic 915 are used to perform inferencing and/or training operations associated with one or more embodiments. Details regarding inference and/or training logic 915 are provided below in conjunction with FIGS. 9A and/or 9B. In at least one embodiment portions or all of inference and/or training logic 915 may be incorporated into processor 1400. For example, in at least one embodiment, training and/or inferencing techniques described herein may use one or more of ALUs embodied in graphics processor 1408, graphics core(s) 1402A-1402N, or other components in FIG. 14. Moreover, in at least one embodiment, inferencing and/or training operations described herein may be done using logic other than logic illustrated in FIGS. 9A and/or 9B. In at least one embodiment, weight parameters may be stored in on-chip or off-chip memory and/or registers (shown or not shown) that configure ALUs of graphics processor 1400 to perform one or more machine learning algorithms, neural network architectures, use cases, or training techniques described herein.

Such components presented herein can allow for improving the PSRR to identify and correct voltage noise within a circuit.

### Virtualized Computing Platform

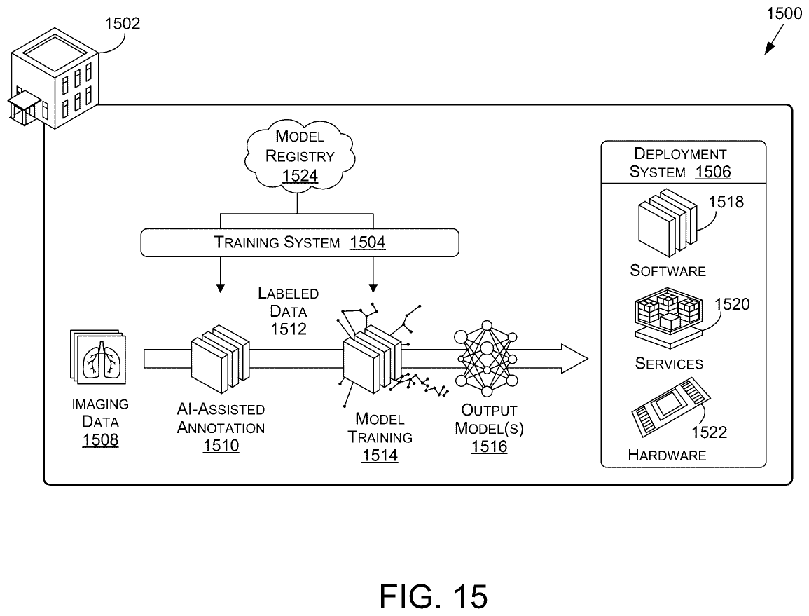

FIG. 15 is an example data flow diagram for a process 1500 of generating and deploying an image processing and inferencing pipeline, in accordance with at least one embodiment. In at least one embodiment, process 1500 may be deployed for use with imaging devices, processing devices, and/or other device types at one or more facility(ies) 1502. Process 1500 may be executed within a training system 1504 and/or a deployment system 1506. In at least one embodiment, training system 1504 may be used to perform training, deployment, and implementation of machine learning models (e.g., neural networks, object detection algorithms, computer vision algorithms, etc.) for use in deployment system 1506. In at least one embodiment, deployment system 1506 may be configured to offload processing and compute resources among a distributed computing environment to reduce infrastructure requirements at facility(ies) 1502. In at least one embodiment, one or more applications in a pipeline may use or call upon services (e.g., inference, visualization, compute, AI, etc.) of deployment system 1506 during execution of applications.

In at least one embodiment, some of applications used in advanced processing and inferencing pipelines may use machine learning models or other AI to perform one or more processing steps. In at least one embodiment, machine learning models may be trained at facility(ies) 1502 using data 1508 (such as imaging data) generated at facility(ies) 1502 (and stored on one or more picture archiving and communication system (PACS) servers at facility(ies) 1502), may be trained using imaging or sequencing data 1508 from another facility(ies), or a combination thereof. In at least one embodiment, training system 1504 may be used to provide applications, services, and/or other resources for generating working, deployable machine learning models for deployment system 1506.

In at least one embodiment, model registry 1524 may be backed by object storage that may support versioning and object metadata. In at least one embodiment, object storage may be accessible through, for example, a cloud storage compatible application programming interface (API) from within a cloud platform. In at least one embodiment, machine learning models within model registry 1524 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1504 (FIG. 15) may include a scenario where facility(ies) 1502 is training their own machine learning model, or has an existing machine learning model that needs to be optimized or updated. In at least one embodiment, imaging data 1508 generated by imaging device(s), sequencing devices, and/or other device types may be received. In at least one embodiment, once imaging data 1508 is received, AI-assisted annotation 1510 may be used to aid in generating annotations corresponding to imaging data 1508 to be used as ground truth data for a machine learning model. In at least one embodiment, AI-assisted annotation 1510 may include one or more machine learning models (e.g., convolutional neural networks (CNNs)) that may be trained to generate annotations corresponding to certain types of imaging data 1508 (e.g., from certain devices). In at least one embodiment, AI-assisted annotation 1510 may then be used directly, or may be adjusted or fine-tuned using an annotation tool to generate ground truth data. In at least one embodiment, AI-assisted annotation 1510, labeled data 1512, or a combination thereof may be used as ground truth data for training a machine learning model. In at least one embodiment, a trained machine learning model may be referred to as output model(s) 1516, and may be used by deployment system 1506, as described herein.

In at least one embodiment, a training pipeline may include a scenario where facility(ies) 1502 needs a machine learning model for use in performing one or more processing tasks for one or more applications in deployment system 1506, but facility(ies) 1502 may not currently have such a machine learning model (or may not have a model that is optimized, efficient, or effective for such purposes). In at least one embodiment, an existing machine learning model may be selected from a model registry 1524. In at least one embodiment, model registry 1524 may include machine learning models trained to perform a variety of different inference tasks on imaging data. In at least one embodiment, machine learning models in model registry 1524 may have been trained on imaging data from different facilities than facility(ies) 1502 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1524. In at least one embodiment, a machine learning model may then be retrained, or updated, at any number of other facilities, and a retrained or updated model may be made available in model registry 1524. In at least one embodiment, a machine learning model may then be selected from model registry 1524—and referred to as output model(s) 1516—and may be used in deployment system 1506 to perform one or more processing tasks for one or more applications of a deployment system.

In at least one embodiment, a scenario may include facility(ies) 1502 requiring a machine learning model for use in performing one or more processing tasks for one or more applications in deployment system 1506, but facility(ies) 1502 may not currently have such a machine learning model (or may not have a model that is optimized, efficient, or effective for such purposes). In at least one embodiment, a machine learning model selected from model registry 1524 may not be fine-tuned or optimized for imaging data 1508 generated at facility(ies) 1502 because of differences in populations, robustness of training data used to train a machine learning model, diversity in anomalies of training data, and/or other issues with training data. In at least one embodiment, AI-assisted annotation 1510 may be used to aid in generating annotations corresponding to imaging data 1508 to be used as ground truth data for retraining or updating a machine learning model. In at least one embodiment, labeled data 1512 may be used as ground truth data for training a machine learning model. In at least one embodiment, retraining or updating a machine learning model may be referred to as model training 1514. In at least one embodiment, model training 1514—e.g., AI-assisted annotation 1510, labeled data 1512, or a combination thereof—may be used as ground truth data for retraining or updating a machine learning model. In at least one embodiment, a trained machine learning model may be referred to as output model(s) 1516, and may be used by deployment system 1506, as described herein.

In at least one embodiment, deployment system 1506 may include software 1518, services 1520, hardware 1522, and/or other components, features, and functionality. In at least one embodiment, deployment system 1506 may include a software “stack,” such that software 1518 may be built on top of services 1520 and may use services 1520 to perform some or all of processing tasks, and services 1520 and software 1518 may be built on top of hardware 1522 and use hardware 1522 to execute processing, storage, and/or other compute tasks of deployment system 1506. In at least one embodiment, software 1518 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1508, in addition to containers that receive and configure imaging data for use by each container and/or for use by facility(ies) 1502 after processing through a pipeline (e.g., to convert outputs back to a usable data type). In at least one embodiment, a combination of containers within software 1518 (e.g., that make up a pipeline) may be referred to as a virtual instrument (as described in more detail herein), and a virtual instrument may leverage services 1520 and hardware 1522 to execute some or all processing tasks of applications instantiated in containers.

In at least one embodiment, a data processing pipeline may receive input data (e.g., imaging data 1508) in a specific format in response to an inference request (e.g., a request from a user of deployment system 1506). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1516 of training system 1504.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1524 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1520 as a system (e.g., processor 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1500 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1500 of FIG. 15). In at least one embodiment, completed and validated applications or containers may be stored in a container registry and associated machine learning models may be stored in model registry 1524. In at least one embodiment, a requesting entity—who provides an inference or image processing request—may browse a container registry and/or model registry 1524 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1506 (e.g., a cloud) to perform processing of data processing pipeline. In at least one embodiment, processing by deployment system 1506 may include referencing selected elements (e.g., applications, containers, models, etc.) from a container registry and/or model registry 1524. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1520 may be leveraged. In at least one embodiment, services 1520 may include compute services, artificial intelligence (AI) services, visualization services, and/or other service types. In at least one embodiment, services 1520 may provide functionality that is common to one or more applications in software 1518, so functionality may be abstracted to a service that may be called upon or leveraged by applications. In at least one embodiment, functionality provided by services 1520 may run dynamically and more efficiently, while also scaling well by allowing applications to process data in parallel (e.g., using a parallel computing platform). In at least one embodiment, rather than each application that shares a same functionality offered by services 1520 being required to have a respective instance of services 1520, services 1520 may be shared between and among various applications. In at least one embodiment, services 1520 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a services 1520 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1518 implementing advanced processing and inferencing pipeline that includes segmentation application and anomaly detection application may be streamlined because each application may call upon a same inference service to perform one or more inferencing tasks.

In at least one embodiment, hardware 1522 may include GPUs, CPUs, graphics cards, an AI/deep learning system (e.g., an AI supercomputer, such as NVIDIA's DGX), a cloud platform, or a combination thereof. In at least one embodiment, different types of hardware 1522 may be used to provide efficient, purpose-built support for software 1518 and services 1520 in deployment system 1506. In at least one embodiment, use of GPU processing may be implemented for processing locally (e.g., at facility(ies) 1502), within an AI/deep learning system, in a cloud system, and/or in other processing components of deployment system 1506 to improve efficiency, accuracy, and efficacy of image processing and generation. In at least one embodiment, software 1518 and/or services 1520 may be optimized for GPU processing with respect to deep learning, machine learning, and/or high-performance computing, as non-limiting examples. In at least one embodiment, at least some of computing environment of deployment system 1506 and/or training system 1504 may be executed in a datacenter one or more supercomputers or high performance computing systems, with GPU optimized software (e.g., hardware and software combination of NVIDIA's DGX System). In at least one embodiment, hardware 1522 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to allow seamless scaling and load balancing.

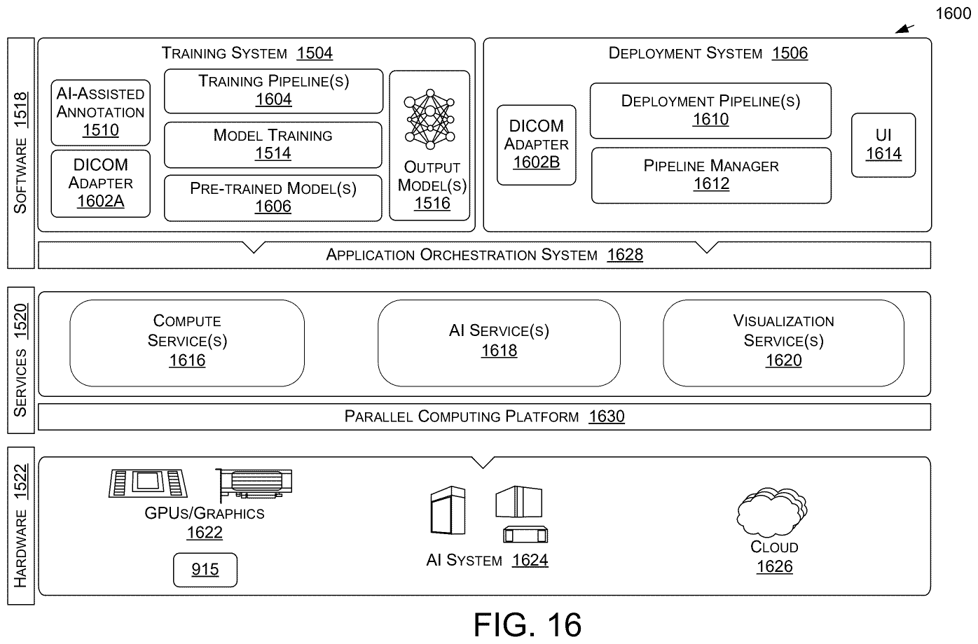

FIG. 16 is a system diagram for an example system 1600 for generating and deploying an imaging deployment pipeline, in accordance with at least one embodiment. In at least one embodiment, system 1600 may be used to implement process 1500 of FIG. 15 and/or other processes including advanced processing and inferencing pipelines. In at least one embodiment, system 1600 may include training system 1504 and deployment system 1506. In at least one embodiment, training system 1504 and deployment system 1506 may be implemented using software 1518, services 1520, and/or hardware 1522, as described herein.

In at least one embodiment, system 1600 (e.g., training system 1504 and/or deployment system 1506) may implemented in a cloud computing environment (e.g., using cloud 1626). In at least one embodiment, system 1600 may be implemented locally with respect to a healthcare services facility, or as a combination of both cloud and local computing resources. In at least one embodiment, access to APIs in cloud 1626 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1600, may be restricted to a set of public IPs that have been vetted or authorized for interaction.

In at least one embodiment, various components of system 1600 may communicate between and among one another using any of a variety of different network types, including but not limited to local area networks (LANs) and/or wide area networks (WANs) via wired and/or wireless communication protocols. In at least one embodiment, communication between facilities and components of system 1600 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1504 may execute training pipeline(s) 1604, similar to those described herein with respect to FIG. 15. In at least one embodiment, where one or more machine learning models are to be used in deployment pipeline(s) 1610 by deployment system 1506, training pipeline(s) 1604 may be used to train or retrain one or more (e.g. pre-trained) models, and/or implement one or more of pre-trained model(s) 1606 (e.g., without a need for retraining or updating). In at least one embodiment, as a result of training pipeline(s) 1604, output model(s) 1516 may be generated. In at least one embodiment, training pipeline(s) 1604 may include any number of processing steps, such as but not limited to imaging data (or other input data) conversion or adaption. In at least one embodiment, for different machine learning models used by deployment system 1506, different training pipeline(s) 1604 may be used. In at least one embodiment, training pipeline(s) 1604 similar to a first example described with respect to FIG. 15 may be used for a first machine learning model, training pipeline(s) 1604 similar to a second example described with respect to FIG. 15 may be used for a second machine learning model, and training pipeline(s) 1604 similar to a third example described with respect to FIG. 15 may be used for a third machine learning model. In at least one embodiment, any combination of tasks within training system 1504 may be used depending on what is required for each respective machine learning model. In at least one embodiment, one or more of machine learning models may already be trained and ready for deployment so machine learning models may not undergo any processing by training system 1504, and may be implemented by deployment system 1506.

In at least one embodiment, output model(s) 1516 and/or pre-trained model(s) 1606 may include any types of machine learning models depending on implementation or embodiment. In at least one embodiment, and without limitation, machine learning models used by system 1600 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1604 may include AI-assisted annotation, as described in more detail herein with respect to at least FIG. 16. In at least one embodiment, labeled data 1512 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1508 (or other data type used by machine learning models), there may be corresponding ground truth data generated by training system 1504. In at least one embodiment, AI-assisted annotation 1510 may be performed as part of deployment pipelines 1610; either in addition to, or in lieu of AI-assisted annotation 1510 included in training pipeline(s) 1604. In at least one embodiment, system 1600 may include a multi-layer platform that may include a software layer (e.g., software 1518) of diagnostic applications (or other application types) that may perform one or more medical imaging and diagnostic functions. In at least one embodiment, system 1600 may be communicatively coupled to (e.g., via encrypted links) PACS server networks of one or more facilities. In at least one embodiment, system 1600 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility(ies) 1502). In at least one embodiment, applications may then call or execute one or more services 1520 for performing compute, AI, or visualization tasks associated with respective applications, and software 1518 and/or services 1520 may leverage hardware 1522 to perform processing tasks in an effective and efficient manner. In at least one embodiment, communications sent to, or received by, a training system 1504 and a deployment system 1506 may occur using a pair of DICOM adapters 1602A, 1602B.

In at least one embodiment, deployment system 1506 may execute deployment pipeline(s) 1610. In at least one embodiment, deployment pipeline(s) 1610 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1610 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1610 depending on information desired from data generated by a device. In at least one embodiment, where detections of anomalies are desired from an MRI machine, there may be a first deployment pipeline(s) 1610, and where image enhancement is desired from output of an MRI machine, there may be a second deployment pipeline(s) 1610.

In at least one embodiment, an image generation application may include a processing task that includes use of a machine learning model. In at least one embodiment, a user may desire to use their own machine learning model, or to select a machine learning model from model registry 1524. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1600—such as services 1520 and hardware 1522—deployment pipeline(s) 1610 may be even more user friendly, provide for easier integration, and produce more accurate, efficient, and timely results.

In at least one embodiment, deployment system 1506 may include a user interface (“UI”) 1614 (e.g., a graphical user interface, a web interface, etc.) that may be used to select applications for inclusion in deployment pipeline(s) 1610, arrange applications, modify or change applications or parameters or constructs thereof, use and interact with deployment pipeline(s) 1610 during set-up and/or deployment, and/or to otherwise interact with deployment system 1506. In at least one embodiment, although not illustrated with respect to training system 1504, UI 1614 (or a different user interface) may be used for selecting models for use in deployment system 1506, for selecting models for training, or retraining, in training system 1504, and/or for otherwise interacting with training system 1504.

In at least one embodiment, pipeline manager 1612 may be used, in addition to an application orchestration system 1628, to manage interaction between applications or containers of deployment pipeline(s) 1610 and services 1520 and/or hardware 1522. In at least one embodiment, pipeline manager 1612 may be configured to facilitate interactions from application to application, from application to services 1520, and/or from application or service to hardware 1522. In at least one embodiment, although illustrated as included in software 1518, this is not intended to be limiting, and in some examples pipeline manager 1612 may be included in services 1520. In at least one embodiment, application orchestration system 1628 (e.g., Kubernetes, DOCKER, etc.) may include a container orchestration system that may group applications into containers as logical units for coordination, management, scaling, and deployment. In at least one embodiment, by associating applications from deployment pipeline(s) 1610 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1612 and application orchestration system 1628. In at least one embodiment, so long as an expected input and/or output of each container or application is known by a system (e.g., based on constructs of applications or containers), application orchestration system 1628 and/or pipeline manager 1612 may facilitate communication among and between, and sharing of resources among and between, each of applications or containers. In at least one embodiment, because one or more of applications or containers in deployment pipeline(s) 1610 may share same services and resources, application orchestration system 1628 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1628) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1520 leveraged by and shared by applications or containers in deployment system 1506 may include compute service(s) 1616, AI service(s) 1618, visualization service(s) 1620, and/or other service types. In at least one embodiment, applications may call (e.g., execute) one or more of services 1520 to perform processing operations for an application. In at least one embodiment, compute service(s) 1616 may be leveraged by applications to perform super-computing or other high-performance computing (HPC) tasks. In at least one embodiment, compute service(s) 1616 may be leveraged to perform parallel processing (e.g., using a parallel computing platform 1630) for processing data through one or more of applications and/or one or more tasks of a single application, substantially simultaneously. In at least one embodiment, parallel computing platform 1630 (e.g., NVIDIA's CUDA) may allow general purpose computing on GPUs (GPGPU) (e.g., GPUs/Graphics 1622). In at least one embodiment, a software layer of parallel computing platform 1630 may provide access to virtual instruction sets and parallel computational elements of GPUs, for execution of compute kernels. In at least one embodiment, parallel computing platform 1630 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1630 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1618 may be leveraged to perform inferencing services for executing machine learning model(s) associated with applications (e.g., tasked with performing one or more processing tasks of an application). In at least one embodiment, AI service(s) 1618 may leverage AI system 1624 to execute machine learning model(s) (e.g., neural networks, such as CNNs) for segmentation, reconstruction, object detection, feature detection, classification, and/or other inferencing tasks. In at least one embodiment, applications of deployment pipeline(s) 1610 may use one or more of output model(s) 1516 from training system 1504 and/or other models of applications to perform inference on imaging data. In at least one embodiment, two or more examples of inferencing using application orchestration system 1628 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1628 may distribute resources (e.g., services 1520 and/or hardware 1522) based on priority paths for different inferencing tasks of AI service(s) 1618.

In at least one embodiment, shared storage may be mounted to AI service(s) 1618 within system 1600. In at least one embodiment, shared storage may operate as a cache (or other storage device type) and may be used to process inference requests from applications. In at least one embodiment, when an inference request is submitted, a request may be received by a set of API instances of deployment system 1506, and one or more instances may be selected (e.g., for best fit, for load balancing, etc.) to process a request. In at least one embodiment, to process a request, a request may be entered into a database, a machine learning model may be located from model registry 1524 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1612) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1520 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1626, and an inference service may perform inferencing on a GPU.

In at least one embodiment, visualization service(s) 1620 may be leveraged to generate visualizations for viewing outputs of applications and/or deployment pipeline(s) 1610. In at least one embodiment, GPUs/Graphics 1622 may be leveraged by visualization service(s) 1620 to generate visualizations. In at least one embodiment, rendering effects, such as ray-tracing, may be implemented by visualization service(s) 1620 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1620 may include an internal visualizer, cinematics, and/or other rendering or image processing capabilities or functionality (e.g., ray tracing, rasterization, internal optics, etc.).

In at least one embodiment, hardware 1522 may include GPUs/Graphics 1622, AI system 1624, cloud 1626, and/or any other hardware used for executing training system 1504 and/or deployment system 1506. In at least one embodiment, GPUs/Graphics 1622 (e.g., NVIDIA's TESLA and/or QUADRO GPUs) may include any number of GPUs that may be used for executing processing tasks of compute service(s) 1616, AI service(s) 1618, visualization service(s) 1620, other services, and/or any of features or functionality of software 1518. For example, with respect to AI service(s) 1618, GPUs/Graphics 1622 may be used to perform pre-processing on imaging data (or other data types used by machine learning models), post-processing on outputs of machine learning models, and/or to perform inferencing (e.g., to execute machine learning models). In at least one embodiment, cloud 1626, AI system 1624, and/or other components of system 1600 may use GPUs/Graphics 1622. In at least one embodiment, cloud 1626 may include a GPU-optimized platform for deep learning tasks. In at least one embodiment, AI system 1624 may use GPUs, and cloud 1626—or at least a portion tasked with deep learning or inferencing—may be executed using one or more AI systems 1624. As such, although hardware 1522 is illustrated as discrete components, this is not intended to be limiting, and any components of hardware 1522 may be combined with, or leveraged by, any other components of hardware 1522.

In at least one embodiment, AI system 1624 may include a purpose-built computing system (e.g., a super-computer or an HPC) configured for inferencing, deep learning, machine learning, and/or other artificial intelligence tasks. In at least one embodiment, AI system 1624 (e.g., NVIDIA's DGX) may include GPU-optimized software (e.g., a software stack) that may be executed using a plurality of GPUs/Graphics 1622, in addition to CPUs, RAM, storage, and/or other components, features, or functionality. In at least one embodiment, one or more AI systems 1624 may be implemented in cloud 1626 (e.g., in a data center) for performing some or all of AI-based processing tasks of system 1600.

In at least one embodiment, cloud 1626 may include a GPU-accelerated infrastructure (e.g., NVIDIA's NGC) that may provide a GPU-optimized platform for executing processing tasks of system 1600. In at least one embodiment, cloud 1626 may include an AI system(s) 1424 for performing one or more of AI-based tasks of system 1600 (e.g., as a hardware abstraction and scaling platform). In at least one embodiment, cloud 1626 may integrate with application orchestration system 1628 leveraging multiple GPUs to allow seamless scaling and load balancing between and among applications and services 1520. In at least one embodiment, cloud 1626 may tasked with executing at least some of services 1520 of system 1600, including compute service(s) 1616, AI service(s) 1618, and/or visualization service(s) 1620, as described herein. In at least one embodiment, cloud 1626 may perform small and large batch inference (e.g., executing NVIDIA's TENSOR RT), provide an accelerated parallel computing API and platform 1630 (e.g., NVIDIA's CUDA), execute application orchestration system 1628 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1600.

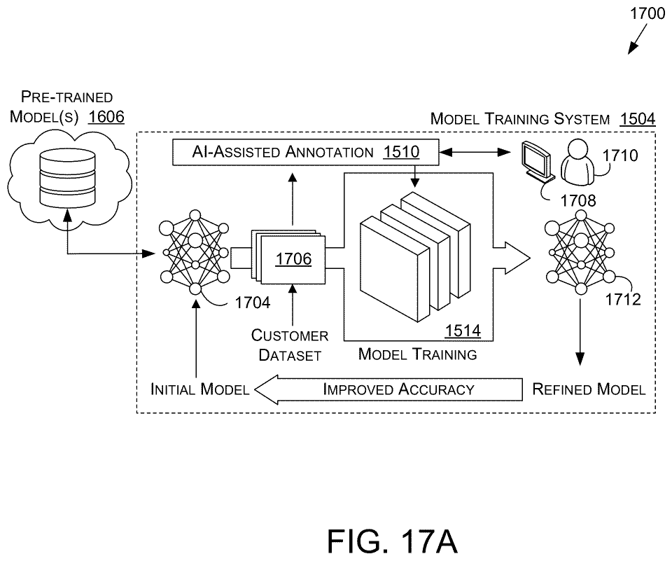

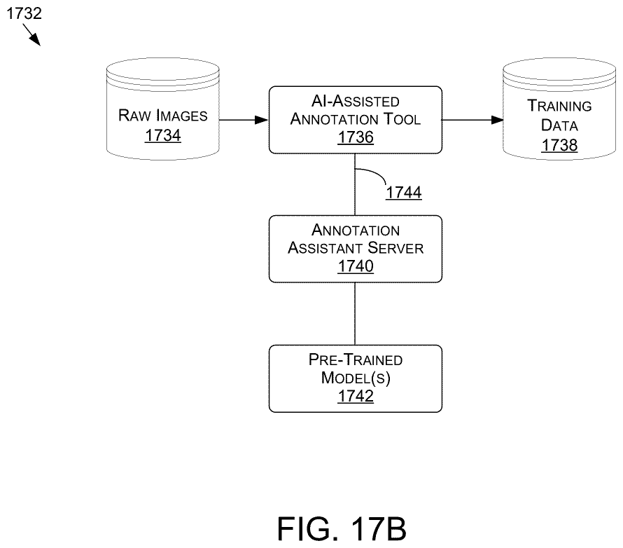

FIG. 17A illustrates a data flow diagram for a process 1700 to train, retrain, or update a machine learning model, in accordance with at least one embodiment. In at least one embodiment, process 1700 may be executed using, as a non-limiting example, system 1600 of FIG. 16. In at least one embodiment, process 1700 may leverage services and/or hardware as described herein. In at least one embodiment, refined model 1712 generated by process 1700 may be executed by a deployment system for one or more containerized applications in deployment pipelines 1610.

In at least one embodiment, model training 1514 may include retraining or updating an initial model 1704 (e.g., a pre-trained model) using new training data (e.g., new input data, such as customer dataset 1706, and/or new ground truth data associated with input data). In at least one embodiment, to retrain, or update, initial model 1704, output or loss layer(s) of initial model 1704 may be reset, deleted, and/or replaced with an updated or new output or loss layer(s). In at least one embodiment, initial model 1704 may have previously fine-tuned parameters (e.g., weights and/or biases) that remain from prior training, so training or retraining 1614 may not take as long or require as much processing as training a model from scratch. In at least one embodiment, during model training, by having reset or replaced output or loss layer(s) of initial model 1704, parameters may be updated and re-tuned for a new data set based on loss calculations associated with accuracy of output or loss layer(s) at generating predictions on new, customer dataset 1706.

In at least one embodiment, pre-trained model(s) 1706 may be stored in a data store, or registry. In at least one embodiment, pre-trained model(s) 1706 may have been trained, at least in part, at one or more facilities other than a facility executing process 1700. In at least one embodiment, to protect privacy and rights of patients, subjects, or clients of different facilities, pre-trained model(s) 1706 may have been trained, on-premise, using customer or patient data generated on-premise. In at least one embodiment, pre-trained model(s) 1706 may be trained using a cloud and/or other hardware, but confidential, privacy protected patient data may not be transferred to, used by, or accessible to any components of a cloud (or other off premise hardware). In at least one embodiment, where pre-trained model(s) 1706 is trained at using patient data from more than one facility, pre-trained model(s) 1706 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1706 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1706 to use with an application. In at least one embodiment, pre-trained model(s) 1706 may not be optimized for generating accurate results on customer dataset 1706 of a facility of a user (e.g., based on patient diversity, demographics, types of medical imaging devices used, etc.). In at least one embodiment, prior to deploying a pre-trained model into a deployment pipeline for use with an application(s), pre-trained model(s) 1706 may be updated, retrained, and/or fine-tuned for use at a respective facility.

In at least one embodiment, a user may select pre-trained model(s) 1706 that is to be updated, retrained, and/or fine-tuned, and this pre-trained model may be referred to as initial model 1704 for a training system within process 1700. In at least one embodiment, a customer dataset 1706 (e.g., imaging data, genomics data, sequencing data, or other data types generated by devices at a facility) may be used to perform model training (which may include, without limitation, transfer learning) on initial model 1704 to generate refined model 1712. In at least one embodiment, ground truth data corresponding to customer dataset 1706 may be generated by model training system 1504. In at least one embodiment, ground truth data may be generated, at least in part, by clinicians, scientists, doctors, practitioners, at a facility.

In at least one embodiment, AI-assisted annotation 1510 may be used in some examples to generate ground truth data. In at least one embodiment, AI-assisted annotation 1510 (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1710 may interact with a GUI via computing device 1708 to edit or fine-tune (auto) annotations. In at least one embodiment, a polygon editing feature may be used to move vertices of a polygon to more accurate or fine-tuned locations.

In at least one embodiment, once customer dataset 1706 has associated ground truth data, ground truth data (e.g., from AI-assisted annotation, manual labeling, etc.) may be used by during model training to generate refined model 1712. In at least one embodiment, customer dataset 1706 may be applied to initial model 1704 any number of times, and ground truth data may be used to update parameters of initial model 1704 until an acceptable level of accuracy is attained for refined model 1712. In at least one embodiment, once refined model 1712 is generated, refined model 1712 may be deployed within one or more deployment pipelines at a facility for performing one or more processing tasks with respect to medical imaging data.

In at least one embodiment, refined model 1712 may be uploaded to pre-trained models in a model registry to be selected by another facility. In at least one embodiment, this process may be completed at any number of facilities such that refined model 1712 may be further refined on new datasets any number of times to generate a more universal model.

FIG. 17B is an example illustration of a client-server architecture 1732 to enhance annotation tools with pre-trained annotation model(s) 1742, in accordance with at least one embodiment. In at least one embodiment, AI-assisted annotation tool 1736 may be instantiated based on a client-server architecture 1732. In at least one embodiment, AI-assisted annotation tool 1736 in imaging applications may aid radiologists, for example, identify organs and abnormalities. In at least one embodiment, imaging applications may include software tools that help user 1710 to identify, as a non-limiting example, a few extreme points on a particular organ of interest in raw images 1734 (e.g., in a 3D MRI or CT scan) and receive auto-annotated results for all 2D slices of a particular organ. In at least one embodiment, results may be stored in a data store as training data 1738 and used as (for example and without limitation) ground truth data for training. In at least one embodiment, when computing device 1708 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1736 in FIG. 17B, may be enhanced by making API calls (e.g., API Call 1744) to a server, such as an annotation assistant server 1740 that may include a set of pre-trained model(s) 1742 stored in an annotation model registry, for example. In at least one embodiment, an annotation model registry may store pre-trained model(s) 1742 (e.g., machine learning models, such as deep learning models) that are pre-trained to perform AI-assisted annotation 1510 on a particular organ or abnormality. These models may be further updated by using training pipelines. In at least one embodiment, pre-installed annotation tools may be improved over time as new labeled data is added.

Embodiments presented herein can allow for dynamic adjustment to UI elements for improved user experience.

Various embodiments can be described by the following clauses:
1. A computer-implemented method, comprising:
   monitoring a plurality of positions at which a user provides input to perform a specific action over time, the specific action associated with a selected region of a user interface;
   determining a drift pattern with respect to the plurality of positions; and
   automatically adjusting a location of the selected region of the user interface, associated with the specific action, according to the drift pattern, wherein further input provided by the user at subsequent positions corresponding to the drift pattern are able to be registered as input to perform the specific action.
2. The computer-implemented method of clause 1, wherein the user interface is provided using a touch screen, and wherein the touch screen does not provide tactile feedback associated with the selected region.
3. The computer-implemented method of clause 1, wherein an amount of the adjusting is based in part on a determined size of the touch screen or space for the user interface.
4. The computer-implemented method of clause 1, further comprising:
   allowing a user or a developer to control an extent to which the location is adjusted.
5. The computer-implemented method of clause 1, wherein the selected region is associated with other input regions corresponding to related actions, and wherein adjusting the location of the selected region further comprises adjusting locations of at least a subset of the other input regions.
6. The computer-implemented method of clause 1, wherein the user is determined to provide input using both a left hand and a right hand, and wherein different drift patterns are able to be detected for the left hand and the right hand to be used in adjusting the location of at least the selected region.
7. The computer-implemented method of clause 1, wherein the input corresponds to touch, gesture, or motion input.
8. At least one processor comprising:
   one or more processing units to:
   monitor a plurality of positions at which a user provides input to perform a specific action, the specific action associated with a selected region of a user interface;
   determine a drift direction with respect to the plurality of positions; and
   provide an adjustment value to be applied to the location of the selected region of the user interface, associated with the specific action, according to the drift direction, wherein further input provided by the user at subsequent positions corresponding to the drift direction are able to be registered as input to perform the specific action.
9. The processor of clause 8, wherein a user interface is provided on the user device using a touch screen, and wherein the touch screen does not provide tactile feedback associated with the selected region.
10. The processor of clause 9, wherein an amount of the adjusting is based in part on a determined size of the touch screen or space for the user interface.
11. The processor of clause 9, wherein the one or more circuits are further to:
   allow a user or a developer to control an extent to which the location is adjusted.
12. The processor of clause 9, wherein the selected region is associated with other input regions corresponding to related actions, and wherein adjusting the location of the selected region further comprises adjusting locations of at least a subset of the other input regions.
13. The processor of clause 9, wherein the user is determined to provide input using both a left hand and a right hand, and wherein different drift patterns are able to be detected for the left hand and the right hand to be used in adjusting the location of at least the selected region.
14. The processor of clause 9, wherein the input corresponds to touch, gesture, or motion input.
15. The processor of clause 8, wherein the processor is included in a system comprising at least one of:
   a system for performing simulation operations;
   a system for performing simulation operations to test or validate autonomous machine applications;
   a system for performing digital twin operations;
   a system for performing light transport simulation;
   a system for rendering graphical output;
   a system for performing deep learning operations;
   a system implemented using an edge device;
   a system for generating or presenting virtual reality (VR) content;
   a system for generating or presenting augmented reality (AR) content;
   a system for generating or presenting mixed reality (MR) content;
   a system incorporating one or more Virtual Machines (VMs);
   a system implemented at least partially in a data center;
   a system for performing hardware testing using simulation;
   a system for synthetic data generation;
   a system for performing generative AI operations using a large language model (LLM),
   a collaborative content creation platform for 3D assets; or
   a system implemented at least partially using cloud computing resources.
16. A system, comprising:
one or more processing units to automatically adjust a position of an input region of a user interface, associated with a specified action, based in part upon a determined drift in input location provided by a user with respect to the input region.
17. The system of clause 16, wherein the user interface is provided using a touch screen, and wherein the touch screen does not provide tactile feedback associated with the selected region.
18. The system of clause 16, wherein an amount of the adjusting is based in part on a determined size of the touch screen or space for the user interface.
19. The system of clause 16, wherein the selected region is associated with other input regions corresponding to related actions, and wherein adjusting the location of the selected region further comprises adjusting locations of at least a subset of the other input regions.
20. The system of clause 16, wherein the system comprises at least one of:
   a system for performing simulation operations;
   a system for performing simulation operations to test or validate autonomous machine applications;
   a system for performing digital twin operations;
   a system for performing light transport simulation;
   a system for rendering graphical output;
   a system for performing deep learning operations;
   a system implemented using an edge device;
   a system for generating or presenting virtual reality (VR) content;
   a system for generating or presenting augmented reality (AR) content;
   a system for generating or presenting mixed reality (MR) content;
   a system incorporating one or more Virtual Machines (VMs);
   a system implemented at least partially in a data center;
   a system for performing hardware testing using simulation;
   a system for synthetic data generation;
   a system for performing generative AI operations using a large language model (LLM),
   a collaborative content creation platform for 3D assets; or
   a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A computer-implemented method, comprising:
monitoring a plurality of positions at which a user provides input to perform a specific action over time, the specific action associated with a selected region of a user interface;
determining a drift pattern with respect to the plurality of positions; and
based at least on the drift pattern, automatically adjusting a location of the selected region of the user interface, associated with the specific action, wherein further input provided by the user at subsequent positions corresponding to the drift pattern is able to be registered as input to perform the specific action.

2. The computer-implemented method of claim 1, wherein the user input is provided using a touch screen, and wherein the touch screen does not provide tactile feedback associated with the selected region.

3. The computer-implemented method of claim 1, wherein a magnitude of the adjusting is based in part on a determined size of the touch screen or space for the user interface.

4. The computer-implemented method of claim 1, further comprising:
receiving control data for controlling a magnitude to which the location is adjusted.

5. The computer-implemented method of claim 1, wherein the selected region is associated with other input regions corresponding to related actions, and wherein adjusting the location of the selected region further comprises adjusting locations of at least a subset of the other input regions.

6. The computer-implemented method of claim 1, further comprising:
detecting the input is provided using both a left hand and right hand;
detecting different drift patterns for the left hand and the right hand, wherein the drift patterns are used in adjusting the location of at least the selected region.

7. The computer-implemented method of claim 1, wherein the input corresponds to touch, gesture, or motion input.

8. The computer-implemented method of claim 1, wherein the drift pattern is monitored by an external motion capturing device.

9. At least one processor comprising:
one or more processing units to:
monitor at least one position at which a user provides input to perform a specific action, the specific action associated with a selected region of a user interface;
determine a drift direction with respect to the at least one position; and
provide an adjustment value to be applied to a location of the selected region of the user interface, associated with the specific action, according to the drift direction, wherein further input provided by the user at at least one subsequent position corresponding to the drift direction is able to be registered as input to perform the specific action.

10. The processor of claim 9, wherein a user interface is implemented using a touch screen, and wherein the touch screen does not provide tactile feedback associated with the selected region.

11. The processor of claim 10, wherein a magnitude of the adjusting is based in part on a determined size of the touch screen or space for the user interface.

12. The processor of claim 9, wherein the selected region is associated with other input regions corresponding to related actions, and wherein adjusting the location of the selected region further comprises adjusting locations of at least a subset of the other input regions.

13. The processor of claim 9, wherein input is provided using both a left hand and a right hand, and wherein the one or more processing units are further to detect different drift patterns for the left hand and the right hand, wherein the different drift patterns are used in adjusting the location of at least the selected region.

14. The processor of claim 9, wherein the input corresponds to touch, gesture, or motion input.

15. The processor of claim 9, wherein the processor is included in a system comprising at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language model (LLMs);
a system implemented using one or more vision language model (VLMs);
a collaborative content creation platform for 3D assets; or
a system implemented at least partially using cloud computing resources.

16. A system, comprising:
one or more processing units to automatically adjust a position of an input region of a user interface based in part upon a determined drift in input location provided by a user with respect to the input region, wherein the input region is associated with a specified action.

17. The system of claim 16, wherein the user interface is implemented using a touch screen, and wherein the touch screen does not provide haptic feedback associated with the selected region.

18. The system of claim 16, wherein a magnitude of the adjusting is based in part on a determined size of the touch screen or space for the user interface.

19. The system of claim 16, wherein the selected region is associated with other input regions corresponding to related actions, and wherein adjusting the location of the selected region further comprises adjusting locations of at least a subset of the other input regions.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language model (LLMs),
a system implemented using one or more vision language model (VLMs),
a collaborative content creation platform for 3D assets; or
a system implemented at least partially using cloud computing resources.
